(19) United States
(12) Patent Application Publication
(10) Pub. No.: US 2004/0015337 A1
(43) Pub. Date: Jan. 22, 2004

(54) Systems and methods for predicting disease behavior

(76) Inventors: Austin W. Thomas, Falls Church, VA (US); Richard D. Thomas, McLean, VA (US); Sterling W. Thomas, McLean, VA (US); Scott J. Hawkins, McLean, VA (US); James K. Parrish, Sterling, VA (US); Diane Weiss, Herndon, VA (US); Lawrence V. Robertson III, North Arlington, VA (US)

Correspondence Address: Michael D. Bednarek, Shaw Pittman, 1650 Tysons Boulevard, McLean, VA, 22102, US

(21) Appl. No.: 10/336,688

(22) Filed: Jan. 6, 2003

Related U.S. Application Data
(60) Provisional application No. 60/344,377, filed on Jan. 4, 2002.

(51) Int. Cl. G06F 17/60; G06G 7/48; G06G 7/58

(52) U.S. Cl. 703/11; 705/3

(57) ABSTRACT

A system and method of predicting disease behavior is disclosed that includes one or more independent components that also interact to produce a prediction of disease behavior based on mathematical modeling of the biological mechanisms and historical patient data.

This application claims the benefit of U.S. Provisional Application No. 60/344,377, filed Jan. 4, 2002, which is incorporated by reference herein in its entirety.

### BACKGROUND

1. Field of the Invention

The present invention relates to systems and methods for analyzing and predicting disease behavior for a purpose of improving diagnosis and treatment. More specifically, the present invention relates to systems and methods for modeling and diagnosing source, occurrence or progression of disease based on data gathered from sources.

2. Background of the Invention

Detection and treatment of disease have been among the most important objectives of scientific advancement throughout medical history. In such pursuit, various techniques and means have been used to detect and treat disease. For example, some conventional medical research studies focus on simulating the characteristics of a disease and its progression throughout the body. By understanding the biological events and interactions as well as the catalysts and contributors to such events and interactions that constitute a diseased condition, researchers and clinicians may determine how best to predict the progression of a disease or how best to treat the disease in a subject or how best to avoid or minimize its effects altogether.

Predicting the behavior of some diseases is especially challenging. One example is cancer, a disease that has been one of the most widespread causes of death for human beings throughout the world. Some treatment techniques for cancer have focused on stopping the progression of cellular events that have been shown to be indicators or instigators of cancerous growth. However, further studies have shown that the progression of cancer is not dependent on a single biochemical pathway or a specific biomolecular signal. Multiple indicators and chemicals have been linked to the diagnosis and progression of cancer. Thus, scientists and physicians must consider multiple variables or factors and their complex interactions and influence upon each other's behavior before accurately detecting cancer and predicting its likely subsequent behavior.

Numerous research findings have produced a great volume of data relating to such possible indicator factors that have been shown to be associated with cancer. For example, specific biomolecules have been linked with the detection and progression of cancerous cell growth. When the effects of certain factors are determined with respect to the overall behavior of a disease, scientists and clinicians may more reliably predict the future behavior of the disease. For example, by determining specific indicator factors and their influence on a specific type of cancer, scientists and clinicians may more reliably predict the subsequent behavior of that specific cancer in a specific subject. This prediction is even more important when individuals indicate factors that may be linked to one another or their collective contribution to the progression of a disease can be identified.

Vast collections of data exist in the medical field. Such data is generally disorganized and inconsistent in the types of measures that are collected. For example, physicians and clinicians all over the world collect and store data relating to their patients in the patient records. Such data is valuable for epidemiologic consideration but is not readily available to anyone other than the physicians and clinicians that are privy to such data. Thus, a valuable wealth of information is lost through such unsystematic manner of data collection and storage. This further prevents interested parties from gleaning knowledge from a data from similar patients treated by other parties. Such lack of widespread data relating to, for example, a particular disease such as cancer, contributes to the slow progression of understanding of disease behavior.

One such specific cancer is colorectal cancer (“CRC”). About 10% of CRC is hereditary and the other about 90% is sporadic. Much less is known about the sporadic form of CRC than the hereditary form, thus, making the detection, and short-term, and long-term diagnosis of sporadic CRC in a patient much more difficult. Therefore, there is a need to understand patterns and factors that influence the formation of sporadic CRC, and the extent to which such factors influence the short-term and long-term diagnosis of the disease. There is a need to more accurately detect and predict such behavior of CRC using accurate, reliable, and consistent laboratory-generated data collected on historical colorectal cancer patients. In addition, it is important to apply novel data analysis approaches to this data with the intent of identifying relationships affecting patient prognosis and treatment at the clinical level. To date, however, there has been no systematic way to gather, organize and analyze historical patient data for either tracking and identification of factors associated with disease, or application of such information in a clinical setting. The lack of organization in assembling the results of studies published in various journals resulting from technical difficulties in assembling and organizing the data has limited the ability to consider the overall discoveries in the data.

Also, there is no system to bring together disparate data access and/or establish a consistent data collection and management protocol. Furthermore, there is no system that makes such data broadly available at the clinical level.

One way in which scientists are managing large quantities of information is through advancements in information technology (“IT”), which have become increasingly utilized in medical science. Researchers and clinicians have used advancements in IT to manage greater levels of laboratory-generated information and published research results, evaluate the information, and access the information more readily. Additionally, IT allows researchers and clinicians to analyze data and draw conclusions in new ways that may surpass the boundaries of traditional scientific tools and thinking. IT is an important aspect of many modern medical and research laboratories and may be used to unveil subtle mysteries that may be hidden within large quantities of data.

IT tools provide diverse capabilities to their users. For example, some IT tools may be instrumental in predicting drug target interactions while other IT tools may be useful in storing and searching large genome databases. Whatever their application, information technology tools have become part of the day-to-day operations of researchers and clinicians. Furthermore, the interplay of IT with biology and medicine has spawned new disciplines, such as bioinformatics.

Even with all its conventional uses, information technology has not yet been utilized to its full potential in unraveling medical mysteries. The ability of IT to allow both researchers and clinicians to look deeper and more directly into causes and appropriate responses to a disease, such as, for example, cancer, as well as to provide a platform for bringing together of and making use of disparate data, has yet to be realized.

There is a need for information technology tools that address the shortcomings of conventional methods of detecting disease and its behavior. These IT tools should be developed such that they are grounded in biological theory and biological interactions. More specifically, such tools should be modeled with respect to the biological mechanisms impacting behavior of a disease, such as, for example growth of a cancer. Additionally, such IT tools preferably should utilize very specific bio-molecular data from patients having a disease such as cancer. Furthermore, such IT tools should accurately represent biological processes and disease progression. To overcome inherent limitations of a single IT application or program, it is important to compare and contrast different IT tools. Furthermore, it is important that a model should be applicable to a variety of different diseases. Thus, there is a need to use IT to create a unique IT tool and make such a tool directly available to researchers and clinicians in an easy to use, reliable, and consistent application based directly on the underlying biological theory and knowledge base.

### SUMMARY OF THE INVENTION

The present invention provides systems and methods for analyzing and predicting diseased behavior for the purpose of improving patient diagnosis and treatment. More specifically, the present invention provides a system and method for modeling and diagnosing source, occurrence or progression of disease based on data gathered from a variety of sources, such as laboratory studies conducted on samples from historical patients. Such systems and methods enable a user to predict the path and progression of disease in a particular patient as based on data gathered and pre-analyzed from many other patients with the same disease. Such a tool facilitates the diagnosis and progression of a disease in a patient, and predicts and projects probable outcomes based on previous patient data. Exemplary embodiments of systems and methods according to the present invention include several components, each with its own function, but wherein their interaction results in an analysis tool for a clinician. Each exemplary embodiment includes a data storage component, a data retrieval component, and a data analysis component. Other components are also possible, and the interaction and sequence of function vary between exemplary embodiments. Two exemplary embodiments are presented herein for sake of simplicity, but the present invention is not limited to these two embodiments, and other embodiments are also possible as long as they perform the same function of diagnosing and/or predicting disease behavior based on historical data and statistical analyses.

An exemplary embodiment of this invention is a system for using a database of patient data to simulate disease progression and identify relationships affecting disease treatment and outcome by analyzing patient specific data in the context of historical data. The system including a database of historical patient data, a system for receiving patient specific data, and a computer system. The computer system is programmed to receive patient specific information, identify and retrieve relevant historical patient data, analyze the patient specific information with respect to the relevant historical patient data, and output information as to the patient's likely response to treatment protocols or suggested treatment options based on the comparison of the patient specific information to the relevant historical patient data.

Another exemplary embodiment of the invention is a system for updating a database of patient data that is used to simulate disease progression and identify relationships affecting disease treatment and outcome by analyzing patient specific data in the context of historical data. The system including means for automatically sending requests for follow up input and providing an incentive to do so, means for receiving and/or storing the information in a defined format, and means for updating the database with the information.

Another exemplary embodiment of the present invention is a system for diagnosing and predicting disease behavior. The system includes a data storage system for storage of historical disease-related data from patients, a data retrieval system for accessing the data storage system and retrieving information relevant to an analysis of a new patient, and a data analysis system that analyzes the historical data and determines patterns which assist in diagnosing and predicting disease behavior in the new patient when data pertaining to the new patient is entered into the data analysis system.

Yet another exemplary embodiment of the present invention is a method for predicting disease progression in a given patient. The method includes entering data specific to the patient, comparing the specific given patient data with historical data stored from many other patients with the same disease, conducting a statistical analysis relating to the behavior of the disease in the given patient with the historical data, and outputting a resultant analysis that predicts the likelihood of disease outcomes in the given patient based on patterns discovered in the historical patient data.

Another exemplary embodiment of the present invention is a method of using a database of patient data to simulate disease progression and identify relationships affecting disease treatment and outcome by analyzing patient specific data in the context of historical data. The method includes prompting the user to provide specific information with regard to a patient, receiving patent specific data, identifying and retrieve relevant historical patient data from a database of patient data, analyzing the patient specific information with respect to the relevant historical patient data, and outputting information as to the patient's likely response to treatment protocols or suggested treatment options based on the analysis of the patient specific information with respect to the relevant historical patient data.

### BRIEF DESCRIPTION OF THE DRAWINGS

FIG. 1 shows an exemplary embodiment of a system according to the present invention including one or more modules that function independently, and also interactively with each other to produce a desired result.

FIG. 2 shows another exemplary embodiment of the development and production states of the present invention as a system for predicting and diagnosing disease behavior.

FIG. 3 describes the functionality of a user interaction component of the system shown in FIG. 2.

FIG. 4 describes the functionality of a customer management system component of the system shown in FIG. 2.

FIG. 5 describes the functionality and implementation of an analysis production component of the system shown in FIG. 2.

FIG. 6 shows a data input component of the production part of the system shown in FIG. 2.

FIG. 7 describes the functionality of an analysis component of the development part of the system shown in FIG. 2.

FIG. 8 shows a schematic of an exemplary embodiment of the bio-math component of FIG. 2.

FIG. 9 shows a data flow diagram according to another embodiment of the analysis production system shown in FIG. 5.

FIG. 10 shows an example of an outcome flow pattern for a given example of bio-math analysis on a particular disease.

### DETAILED DESCRIPTION OF PREFERRED EMBODIMENTS

The present invention allows a user to analyze patient specific data in the context of historical patient data, and to diagnose and predict the progression of a disease, such as, for example, cancer. Two exemplary embodiments are described below, each with its unique components and component interactions. However, each embodiment performs the same function of predicting and analyzing disease progression. Thus, although there are some differences between the components and functions of components in each embodiment, the overall functionality of each of the systems is maintained. In one exemplary embodiment, the present invention includes a plurality of modules that operate independently and also interactively as a system. In another exemplary embodiment of the present invention, the system includes a mathematical module; an “intelligent system” module; a statistical module; a rule-based module; a historical patient database; a customer records management system; and a report generation and transaction processing function. Other exemplary embodiments that are also possible and are within the scope of the present invention as long as they perform the same function of predicting disease behavior or diagnosing disease condition.

The components or “modules” generally are intended to represent certain critical functional components that together provide users, such as physicians, with a comprehensive and unique analytical representation of disease, its progression, and potential intervention. These functional components include, among others, data organization/cleansing, biosystem/mechanism representation; relationship identification; prediction/treatment protocols, disease analysis and prediction; disease data; analytical validation and comparison. The system is designed to leverage these functional elements with the capability to substitute or evolve the specific technical applications employed to execute the functions.

The mathematical module predicts the behavior of a disease based upon a mathematical model of biological events related to the disease. The “intelligent system” module, which may be based on a neural network system, provides prediction of disease progression and/or outcome based upon a specific individual's data and is based on a database of historical data for a patient population. The statistical module primary function is to identify relationships within historical patient records that can then be used to predict patient longevity and/or treatment response. Additional potential functions include comparing and evaluating the results of the individual's data with respect to the historical data for a patient population and performing data organization and cleansing in addition to data validation and quality control, data checks and balances. The rule-based module provides outcome predictions, treatment recommendations, and clinical trial matching by using relationships gathered from the statistical analysis of the historical patient database, standard medical protocols, and clinical trial databases. A final report comparing and evaluating numerous outcomes of the specific individual's data set within various modules may be produced.

An advantage of a system according to an exemplary embodiment of the present invention over conventional systems is this system's inclusion of historical data for a patient population including bio-molecular data for each patient and this system's modeling of disease using complex mathematics. Additionally, this system may be used to identify patterns within the molecular, general medical, demographic patient data and determine the significance of genetic and protein events on treatment and outcome of patients. Furthermore, this system assesses disease from a biological mechanism foundation, employs multiple unique analytical methods, and allows both user interaction in the analysis approach as well as treatability of analysis results over the progression of the disease in an individual patient. Some additional advantages to the system include: flexible platform capable of application to multiple diseases; flexible with respect to utilizing technological advancements; only objectively presenting data to doctors and allowing them to make treatment decisions for their patients.

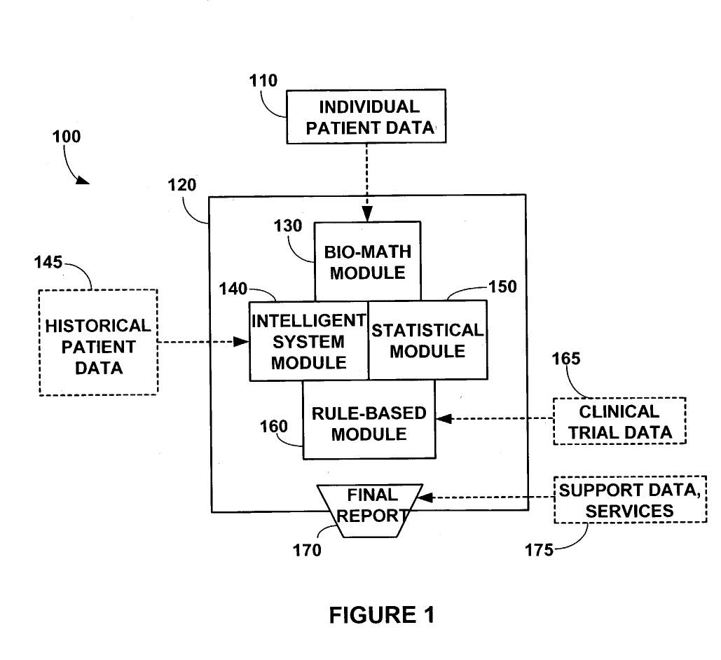

FIG. 1 shows an exemplary embodiment of the present invention as a system 100 for evaluating data information regarding the behavior of a disease. Alternatively the modeling system 120 may be provided with access to historical patient data 145, which may be stored separately from the system 120. The historical patient data 145 may contain necessary data that would be beneficial in predicting the behavior of a disease.

For example, such historical data sets 145 could include demographic, diagnostic, treatment and outcome data. Additionally, historical patient data 145 could contain molecular marker data with respect to specific data findings in each patient. Such molecular marker data could be, for example, determined in a laboratory and used to quantifiably correlate a measured level of a biomolecule. Through analysis of this historical data set 145, it will be possible to identify relationships within the data set and train the system to predict clinical outcome and recommend treatment options for a new individual patient when only the patient's diagnostic and demographic data 110 is known.

Once an individual patient's data 110 is input into the modeling system 120, the data is considered by the bio-math module 130. Other models for data storage, flow, and analysis are possible. The bio-math module 130 will be described in more detail below.

Briefly, this bio-math module 130 is designed to predict, through mathematical models of biological systems, the behavior of a disease according to one or more factors or conditions. The individual patient data 110 that was introduced into the system 120 preferably has information relating to such factors and conditions that are used in the bio-math module 130. However, even in the absence of certain desired markers or information, the bio-math module can predict the missing values and produce an outcome. More importantly, the value or relevancy of the system's overall outcome is not dependent on the value or relevancy of the outcome of any one module.

Data that flows out of the bio-math module 130 can be directed to an intelligent system module 140, which will be described in more detail below. Briefly, the intelligent system module 140 provides a prediction for an outcome and/or treatment of an individual patient based upon analysis of the historical data, which may or may not contain the bio-math output 145. Such analysis may be, for example, non-linear analysis. This intelligent system module 140 could also consider and examine more complex data relationships than conventional clinical settings and can provide insight into disease behavior patterns. For example, the intelligent system module 140 may determine growth factors relating to cancer from an examination of the historical patient data 145. Further relationships between the data, particularly molecular factors, and resultant outcome may be discovered through data analysis by first deriving a relationship between sets of data, and then considering future relationships based on these derived sets of relationships.

A statistical module 150 can perform statistical analysis on the data sets evaluated by the intelligent system module 140, the bio-math module 130, or directly resulting from inputs of patient or historical data. The primary function of the statistics module is to operate within the analysis development component of the system to identify relationships within the historical patient records that will then be used by the rule based system in predicting prognosis and recommending treatment protocols. In addition, the statistical module 150 can be used to validate the output of the other modules. Such evaluation and validation results in reliability analysis of the outcome based on standard statistical techniques and measures, such as, for example, r and r². Such statistical modules 150 may be conventional statistical systems commercially available or specifically designed or modified for such a system 120. Statistical reliability measures provided by the statistical module 150 provides a level of confidence to researchers and clinicians and gives a sense of the predictability of the model in consideration.

A rule-based module 160 analyzes data and contains a knowledge base of relationships discovered by other modules as well as a knowledge base of cancer treatment in both general terms and of specific clinical trials. The rule-based module 160 receives the outputs of other analysis modules as well as the specific patient data and determines the standard treatment course, and any alternative treatment course(s) if indicated by the results of the analysis modules.

To describe a function of the rule-based module in more detail, an example will be used. If the data that is collected for various cancer patients show that a given marker of a given protein signifies a higher than normal likelihood of developing that specific type of cancer, then that marker will be used as an indicator of the cancer within the rule-based module 160. Such discoveries of relationships are beneficial for predicting future outcome in similar circumstances. For example, if a given treatment protocol has been markedly beneficial when a given set of data is noted for a patient, then such treatment protocol will be recommended for future patients that display the same or similar set of data. These are mere examples of various ways where the rule-based module 160 may be used to analyze and predict disease, and recommend treatment. Other methods of analysis, prognosis and treatment are also possible.

The modeling system is initiated and managed by a customer management system (CMS) and interfaces that direct the flow of data and tracks the use and flow of data through the analysis. In addition, it is intended to manage the customer transaction from input of data to return of the final report. CMS acts as a data repository which may be acted upon by one or more interfaces, such as, for example I2.

A final report 170 is generated from the results of the outcomes of the one or more modules in the system 120. The final report 170 may be modified or structured according to external variables, such as support data or services 175, and serves to provide the researcher or clinician with the requested information produced from the analysis of the system 120 and related detailed support for the analysis output, analysis methods, and methodology support. Such support could include journal reference, summation of protocol applied, analysis method and sequence description, or records of data point types, and completeness of data.

As described above, each of the modules and components of the system 100 contributes an integral component to the overall functionality of the system 100. Each module also represents a function critical to the overall system. However, the system and its methodology are not constrained by the type of technology employed to execute the function. Technology employed can be altered, substituted or eliminated without constraining the viability or function of the system 120. Now, the modules and its functionality and properties will be described in more detail.

The bio-math module 130, as described briefly above, can mathematically model biological mechanisms and can generate an aggressiveness score based on an index. To accomplish such tasks, the bio-math module 130 may rely on molecular marker data from research conducted in a laboratory. For example, by inputting values from immunohistochemistry data into mathematical equations representing biological mechanisms, the bio-math module 130 strives to simulate the biology of a tumor. The simulation may in turn provide valuable information related to the aggressiveness of a tumor, which is an indicator of the measure of the stage, severity and speed of cancer. Based on this information alone, users of the system 120 may be provided with valuable information regarding the molecular makeup of a tumor, and the molecular makeup influencing the manner the patient should be treated. Furthermore, the mathematical models may provide additional information regarding relationships between factors that will aid researchers in confirming such relationships in a laboratory setting.

Some of the data contained in the historical patient database 145 that will be analyzed could include a numeric description of protein levels in disease patients. The math models provide a translation system for this data. The endpoint of any modeling system is the solution to a problem that is not well understood without the model, or too difficult to obtain without the model. Thus, the biological models of this system will model the internal mechanisms of disease based upon the relative levels or existence of proteins and/or gene expression that make up the mechanisms. Often times, these molecular mechanisms are very complex and non-linear, making it difficult to define specific relationships within the mechanism and between the mechanism and disease. Conventional laboratory experiments and their results often fall short of being able to describe the relationship between the mechanisms and the disease they affect and can be very resource-consuming. Using mathematics, the combination of multiple biological markers, such as, for example, identified proteins, may be used to simulate these mechanisms, which are important to the management and treatment of the disease.

Although some conventional efforts in modeling specific molecular mechanisms within a disease system have been made, such efforts to draw significant conclusions from the models have been unsuccessful because the models were generated using representative data that does not mirror actual biology. In developing the biological models of the system 120, actual patient data, such as, for example, for CRC patients, are used in an effort to simulate the true biology of the disease.

The biological models of the bio-math module 130 may use several different mathematical software packages and theoretical approaches. With respect to the mathematical theory, ordinary differential equations (“ODEs”) and kinetic logic may be used to model the biological mechanisms. ODEs could be used because of their ability to accurately represent the sigmoid nature of biological mechanisms. Kinetic Logic expressions are discrete step functions that can convert a sigmoid expression into a timed step function. The reason for using such an approach is that the data available will not always support the use of ODEs. Kinetic logic makes use of defined limits that do not require exact protein concentrations while the use of ODEs requires precise concentrations.

Mathematical simulation is partially dependent on the accuracy and precision of the experimental data. The accuracy of the data cannot be improved by mathematical means. The bio-math module 130 is designed to accept data. For example, three levels of data that the bio-math module 130 may accept include: exact concentrations of proteins, percentage of cells positive (IHC), and existence of protein. The incongruity of the data that will be modeled requires the use of different modeling approaches. ODEs will only accept precise concentration data while kinetic logic will accept data relative to the percentage of cells positive for the stained protein and or whether the protein exists at all in a sample.

As discussed above, biological modeling is used for the purpose of creating a mathematical model of a dynamic biological function. This is in contrast to statistical, such as, for example, epidemiological, models where the models assume a static environment. One of the challenges in creating mathematical models is the ability of biological models to accurately describe a dynamic situation from multiple static measurements. A theory behind the bio-math module 130 relates the concept of a static point in conjunction with facts concerning the environment of the reaction and results in a model that accurately describes a dynamic biological function.

An exemplary bio-math module 130 is developed using specific methods. The products that result from the methods are biological algorithms that represent specific dynamic biological processes. The methods could include one or more steps. A first step is to research the specific mechanism involved. Some areas that should be researched include: contributing processes, enzymes involved, location of mechanisms, for example, cytoplasm versus membrane, and others. The purpose of this first step is to accurately gather and describe information that could be represented.

A second step could be to create a two-dimensional diagram of the mechanism that is being modeled. A third step could be to identify variables and constants, and replace them with terms that will be used in the equations. A final step would be to translate the map into an actual mathematical expression. The result of these steps is then integrated into the optimization process.

The process of optimization could include six steps. A first step includes considering the steps required to create the model. A second step is to determine constraints for the bio-math system. The constraints may be determined, for example, by research into scientific rules, laws, and theories that would control the protein concentrations. A third step is to identify the unknown variables. Like other variables in the model, the unknown variables may have limits that have to be addressed with constraints in a fourth step. A fifth step includes the steps required for the development of the optimization system. In a final step, the unknowns in the models are given initial numeric values. These values are simply starting points for the process of optimizing the models. The model is then run with the initial values. The concentrations of the proteins that are produced by the model are then compared to the concentrations from human data, and which difference is described as delta. The delta is then used to create a fitness for the initial values and the optimization system runs and produces and new set of values and step six is repeated. The process stops when a measure of delta becomes small enough to be considered insignificant.

The bio-math module 130 may also create an aggressiveness index. The aggressiveness index is the result of the mathematical algorithms and is in the form of a numeric range. An expression or manifestation of the disease in question would be assigned a value within the index that would describe the aggressiveness of the disease. The aggressiveness of a disease is defined as the speed and invasiveness of the growth of the symptoms of the disease, such as, for example, a tumor. The purpose of this index would be to better define the growth characteristics of the disease.

In assignment of an aggressiveness index to a disease, the mathematical models in the bio-math module 130 will calculate, for example, concentration of proteins or relationship between concentrations during a specific stage of the disease. The model will have the ability to represent the protein concentrations and relationships between concentrations at any time during the existence. Furthermore, the model will not be limited to a particular stage of the disease; this also includes the creation of the aggressiveness index.

As a non-limiting example, Cyclin E, a class of proteins that fluctuate in concentration at specific points during the cell cycle and that regulate the cycle by binding to a kinase, and E2F are an example of a positive loop. E2F promotes cyclin E. Cyclin E then promotes itself. The next protein is pRb, which is promoted by cyclin E, which then promotes E2F to progress the cycle. In this example, there are no direct inhibitors (within the cycle) that affect the overall function of the cycle. Considering again the inhibitors, such inhibitors include TGF-beta and p21, p27, and p57. These inhibitors are not directly involved in the cyclin E cycle, but do directly affect the participants of the cycle. Other events may also be used as indicators, such as, for example, immune response mechanisms, growth factors, growth factor receptors, apoptotic markers, and the like.

The goal of this system is to promote the progression of the cell cycle. The cyclin E cycle's purpose is to produce the required concentration of cyclin E, which will then bond to the cyclin dependent kinase 2. When this complex is formed and phosphorylated, it assists the cell to go into the next stage of the cell cycle.

The mathematical model of this system would include terms for all included proteins, including promoters and inhibitors. Other molecular structures that may be used include, but are not limited to, plasma markers, peptide fragments, gene analysis markers, or the like. The inhibitors would have a negative effect on the concentration of the cyclin E cdk2 (E/2) complex (for example, TGF-beta inhibits cyclin E). E2F would be a promoter and would hold a positive effect on the E/2 concentration. The relationship between the promoters and the inhibitors would constitute the major portion of the algorithm. The lesser portion would include constraints that would limit the production of cyclin E based on the availability of pRB. Essentially the concentration of cyclin E cannot exceed the value n multiplied by the concentration of pRB (n representing the number of cyclin E proteins that can be produced/activated with the assistance of a single pRB protein). Considering such biological reactions, a mathematical model is devised and stored into the bio-math module 130 to be used for consideration in, for example, patients that may be deficient in such biological pathways resulting in disease.

Thus, to summarize, the mathematical modeling used in the bio-math module 120 has several purposes. The mathematical modeling will provide insight into the effects that molecular events have on both the internal mechanism and pathways controlling disease progression as well as their overall effect on phenotypic expression. Also, the mathematical output will include an aggressiveness index and score that acts as an additional diagnostic data point and relates to disease aggressiveness. The aggressiveness of a disease is defined as the speed and invasiveness of the growth of the symptoms of the disease (i.e. tumor). The purpose of this index would be to better define the growth characteristics of a disease. Thus, the bio-math module 120 will provide diagnostic data points relating to cellular events, thereby providing researchers and clinicians insight into inter-relationships of molecules that may be verified in a laboratory.

As described briefly above, the intelligent system module 140 provides a prognosis for the outcome and/or treatment of a patient based on analysis, for example, non-linear analysis. The intelligent system 140 will have access to historical patient data 145 that is separately stored from the system for the purpose of training the system to receive new patient records and predict outcome 140. The historical patient record contains data on demographic, diagnostic, treatment and outcome information in addition to potentially receiving the agressiveness score generated by the bio-math module 130.

Once these records have been input into the system 140, the intelligent system, potentially a neural network will analyze the records for patterns that it will later use in predicting missing fields, such as treatment and outcome fields, in new patient records. The purpose of this system will be to provide an outcome prediction and/or initial treatment recommendation that is based on information the intelligent system has “learned” from other patients. During the development stages, the intelligent system predictions will be fed into other modules for confirmation of the validity of the prediction as well as to identify the relationship within the data that the prediction was based on. The approach that the intelligent system is very similar to the methods a physician will use in making treatment and outcome decisions for their patients. The advantage to this system is that it has the ability to remember every data point for every patient it has ever considered and can draw from an unlimited number of historical records.

There are several advantages and functions of artificial intelligence in both the development and operational phases of the intelligent system module 140. As a non-limiting example, HNET's Artificial Neural Network (“ANN” or “neural network”) may be used to act as an artificial intelligence component intelligent system for several reasons. One reason for such a use is that HNET's technology is based on a different algorithm than traditional neural networks.

ANN could have one or more functions. First, the ANN will be able to analyze the database to ensure sufficient breadth and depth of data for any individual query. Such a function will be valuable in identifying if the amount of data in the database of patients is viable and sufficient for the data mining function of the intelligent system. In order to illustrate this function, a non-limiting example will be provided.

For example, considering that for an analysis, 500 patients must be analyzed from a historical research database 145. A filter attached to the ANN would scan the database and pull out the desired patient records. At this point, the neural network would be able to go through the records and scan for null fields within patient records or identify fields where more than one entry was provided for that particular field. If applying this same function to a new patient record, the neural network would not only be able to scan the new record for null fields but there is also the possibility that based upon what the neural network has learned from the historical data, it would be able to fill in the field with the correct or most probable information.

In addition to the database scanning function of the neural network, there is also a data mining function that will be utilized in facilitating the identification of potentially significant relationships. One advantage of the ANN is its ability to analyze large numbers of data points. Whereas statistical methods are limited in the number of fields it can analyze, the neural network has the ability to continually “learn” as the data fields and patient records increase. For example, as the neural network goes through the database it will “learn” from the historical patient records it has seen and identify patterns within the data that allow for the prediction of null fields in new patient records. Null fields may include items such as treatment and outcome data in the database. Once the neural network has made its predictions and has done so in a consistent manner, the relationships within the data that are responsible for the prediction can be identified through additional methods. The relationships that the neural network helps identify can then be checked for statistical significance through the statistics component of the system and added to the knowledge base of the system.

The statistical module 150 is one of the modules that will receive input from the intelligent system module during the development process 140. Conventional statistical analyses will be conducted to identify existing relationships that allow the intelligence system module 140 to make treatment and outcome predictions. In addition, the statistical module 150 will be used to confirm other results or relationships that are derived in the other analysis modules. The statistical module is helpful to the overall system because it uses accepted conventional methods to confirm that relationships and predictions generated are valid. An advantage of this module 150 is that it is an accepted method that is well understood both by the research and treatment community. It is also a proven method for confirming the existence of observed relationships.

The three modules 130, 140, and 150 previousely mentioned will generate data that indicates the existance of relationships that have potential bearing on how a patient will respond to a particular treatment or what their general outcome may be. Once a relationship has been identified either through information technology, general literature, or new laboratory research, the relationship will become part of the rule based system 160. This module 160 can be viewed as a decision tree type format where several “If/then” statements can be implemented to arrive at the treatment and outcome recommendations for each individual patient. It is also within this module 160 that a comparison can be made between the results of the system 120 and standard protocols currently used by physicians in predicting treatment and outcome data. In addition, data from completed clinical trials 165 and other literature sources of information will add another layer to the decision trees and provide a third prediction of most effective treatment and outcome for each patient.

The present invention is not limited to the exemplary embodiments described with respect to FIG. 1. Other exemplary embodiments are possible, as long as the overall goal of the system is to assist a clinician or scientist in evaluating a patient's medical condition and/or possible diagnostic-treatment options. Furthermore, although the above exemplary embodiments of the present invention was described with specific modules having specific functions, the present invention is not limited to such a system and/or modules. Other systems and/or module combinations are possible.

The present invention is designed to be flexible to conform to the specific goals and unique characteristics of different medical problems. As another non-limiting example, consider two patients that have similar demographics and disease characteristics, and wherein identical treatments are administered. One patient responds to the treatment while the other does not. It is unclear why there are differences in reaction although each has the same disease. A desired solution is sought to predict which treatment will be more beneficial for a particular patient.

A first step in trying to identify a desired solution to the diverging results is to identify the molecular pathologic differences between patients in order to further distinguish each patient. Next, diagnostic tools should be developed to differentiate tissue samples, such as histologically similar tumors. Next, targeted therapies are developed to address the affected tissues. Finally, a tool is desired to accurately predict patient prognosis with associated treatment regimens.

The inventors of the present invention have proposed to use research data from a variety of methods to build a tool capable of predicting treatment outcomes based on patient molecular, diagnostic, and demographic profiles. A diagnostic tool is developed to address treatment outcomes. Such a tool is based on a given data set, which for this example, is a data set of 504 patients consisting of: diagnostic and demographic data including five year survival data for each patient; immuno-histochemical data on a combination five or more protein markers related to cancer development in each patient; and representative Caucasian and African-American patients.

In one particular aspect of the present invention, a bio-math calculation is used to quantify tumor aggressiveness based on patient molecular profile and mathematical relationships of the proteins. To arrive at such a value, certain developmental inputs are needed, such as, for example, protein markers for individual patients and survival data. Certain developments are produced, such as, for example, refined algorithms representing cellular pathways capable of receiving functional inputs. Functional inputs that would be needed to assess a particular patient include, for example, protein expression data on the patient. Functional outputs of the system include, for example, a tumor aggressiveness score.

In another aspect of the present invention, a neural network is developed that predicts patient outcomes based on “learned” patterns existing in historical patient records. Training inputs needed for this aspect include, for example, historical patient aggressiveness score, and molecular, diagnostic, demographic, treatment and outcome data. Training outputs from the neural network include, for example, a trained neural network. Functional inputs into the system include, for example, individual patient aggressiveness score, and molecular, diagnostic, demographic, and potential treatment options. Functional output include, for example, treatment associated outcomes for an individual patient.

In yet another aspect of the present invention, a rule-based system is developed that serves to match patients with facts related to best available treatment options as identified through statistical analysis of similar historical patients, as well as standard protocols. This system also matches patients to open clinical trials. Functional inputs into this system include, for example, individual patient aggressiveness score, and molecular, diagnostic, and demographic data, and clinical trial preferences. Functional output of this system include, for example, recommended treatment from standard protocol, recommended treatment from data collected and considered by the system, available clinical trial profile, and patient specific cancer statistics and information.

In considering the above aspects of the present invention, including, for example, the bio-math, the neural network, and the rule based systems, certain clinical applications may be made. For example, with colon cancer, as part of general pathology work-up, a clinician may order IHC stains for protein markers of interest. The clinician then inputs the IHC results as well as patient diagnostic and demographic data into a web page, to send to the system where analysis is conducted. Resultant data is produced and relayed back to the clinician, including for example, tumor aggressiveness data, potential treatment options and predicted outcomes, a list of available clinical trials the patient matches, and patient-specific cancer information and statistics. This system substantially decreases the effort involved in gathering information from a patient and considering numerous treatment options before making a recommendation. Furthermore, because the resultant data provided to the clinician is based on a plurality of previous patient data, the recommended course of treatment is based on proven data that best matches a particular patient's characteristics.

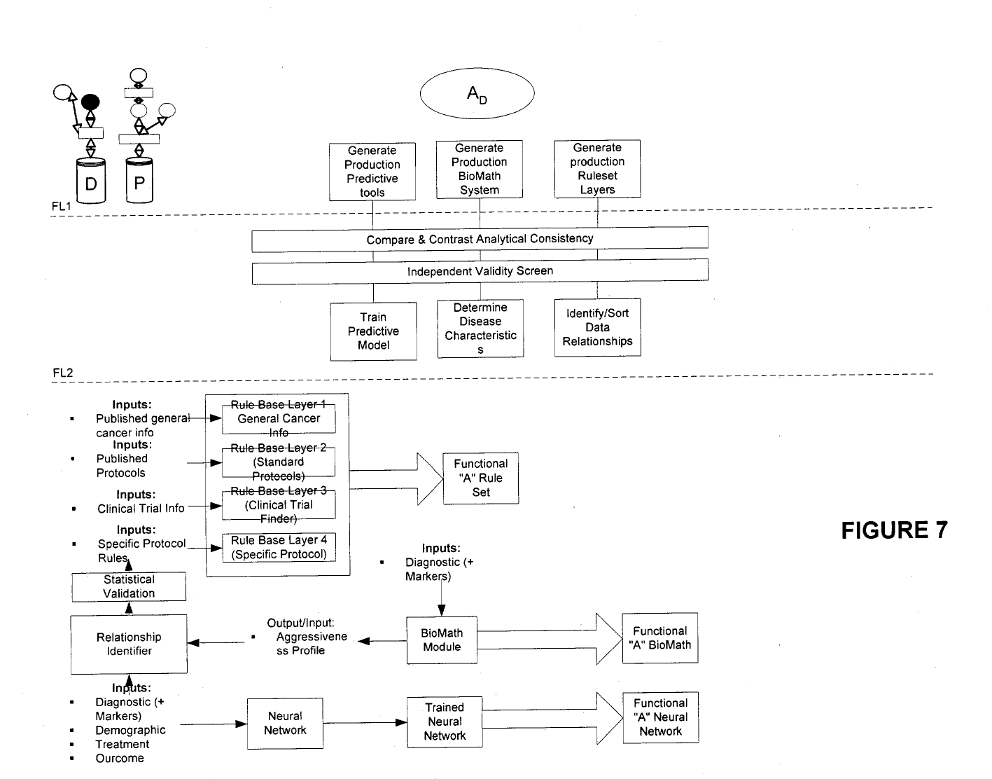

Although the exemplary embodiments of the present invention are shown and described in a particular manner, there is virtually no limit as to how the present invention may be used. The flexibility of the system allows a user to choose which variables define the operation of the system. For example, an oncologist who is presented with a patient having a node negative tumor extending into the muscularis propia (T2,N0,M0) may have to consider whether an adjuvant therapy should be recommended. After submitting patient data, a system according to the present invention may present information that the patient has a marker profile consistent with more aggressive disease and increased risk of recurrence. Thus, the oncologist considers this more urgent prognosis and determines treatment options. The oncologist uses such a system as an additional tool for discussing options with his or her patients and in making recommendations based on scientific data. An exemplary embodiment of the system that assists the oncologist in this example is now shown and described in FIG. 7.

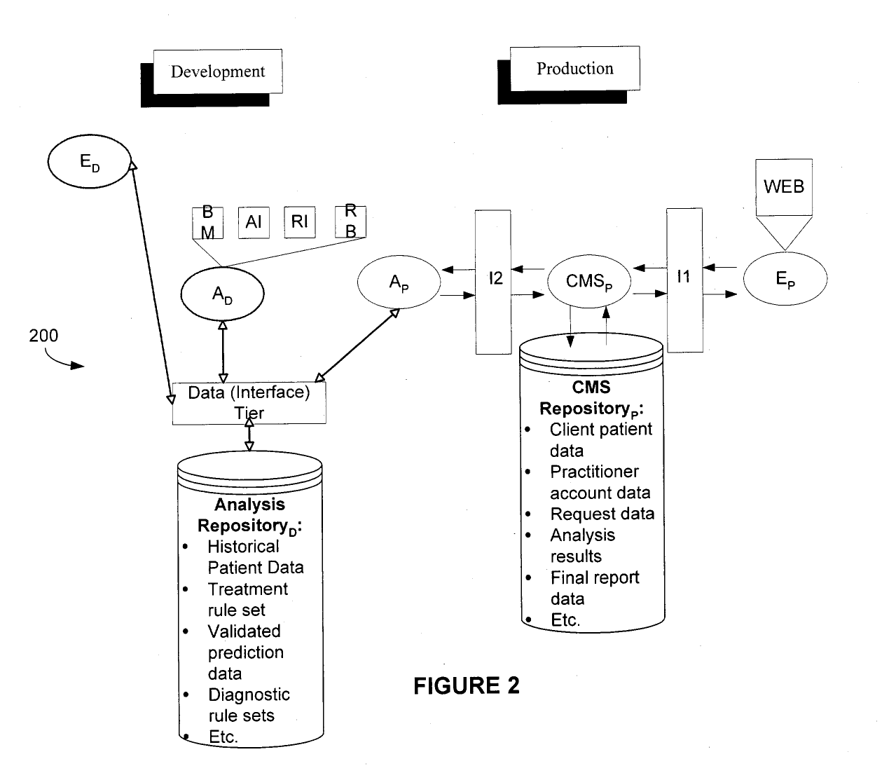

An exemplary embodiment of the present invention is shown as system 200 in FIG. 2. The system 200 presents a complete analysis tool from a user interface, through individual patient data analysis, to delivery of analysis to the clinician. The exemplary system 200 shown in FIG. 2 presents solutions to any party in the medical community by addressing many problems that are faced by clinicians and the healthcare community in seeking to diagnose and treat disease. For example, if there are multiple patients with similar demographic and disease characteristics, but who respond differently to the same treatment regime, a problem arises in that it is unclear why such different results occur and how they may be resolved. Then a proposed solution set is proposed for this problem.

Such a solution set is the basis in the functionality of system 200. The solution set has four main components: (1) identification of the molecular pathway differences between patients; (2) development of diagnostic tools to differentiate histologically similar disease manifestations; (3) development of target therapies; and (4) development of tools to accurately predict patient prognosis and associated treatment regimes.

System 200 addresses each of solution components (1) through (4) by providing the tools or actual analysis that support a clinician's ability to resolve the problem. The goal of system 200 is not intended to dictate to the clinician what the treatment must be, but to provide the clinician with patient-specific information to allow the clinician to determine how to best treat their patient.

The data used as a backdrop in system 200 in proposing treatment options is derived from a variety of sources and from different data collection approaches. Such data should be capable of predicting treatment outcomes based on patient molecular, diagnostic and demographic profiles when combined with clinician-selected treatment regimes.

Described in more detail below are three analysis subsystem components that are incorporated into system 200. A goal of the system 200 is to develop an analytical tool. Any technology that is described with respect to system 200 is merely exemplary in achieving this goal, and other technology may also be used. Several functions of system 200 include, but are not limited to, quantifying disease aggressiveness based on molecular, diagnostic and/or demographic profile, predicting patient outcomes based on “learned” patterns in comparable historical patient records, and matching individual patients with diagnostic, treatment, and outcome facts related to similar cases, either real or analytically amalgamated. The exemplary tools used to achieve these three listed functions include bio-math algorithms and technology, neural networks, statistics and rule-based technology, respectively.

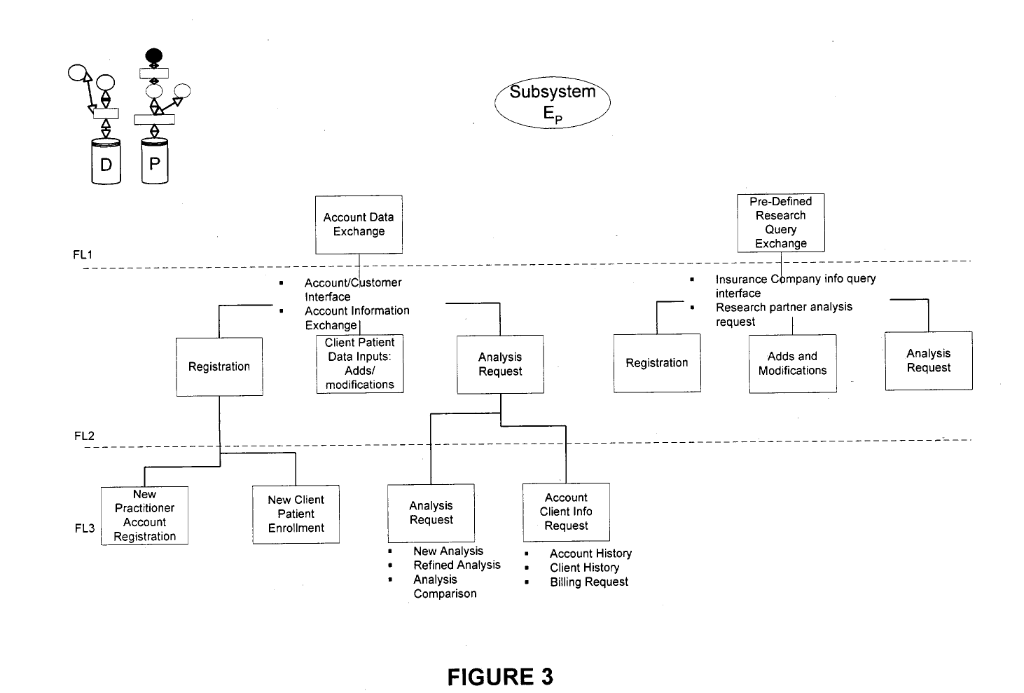

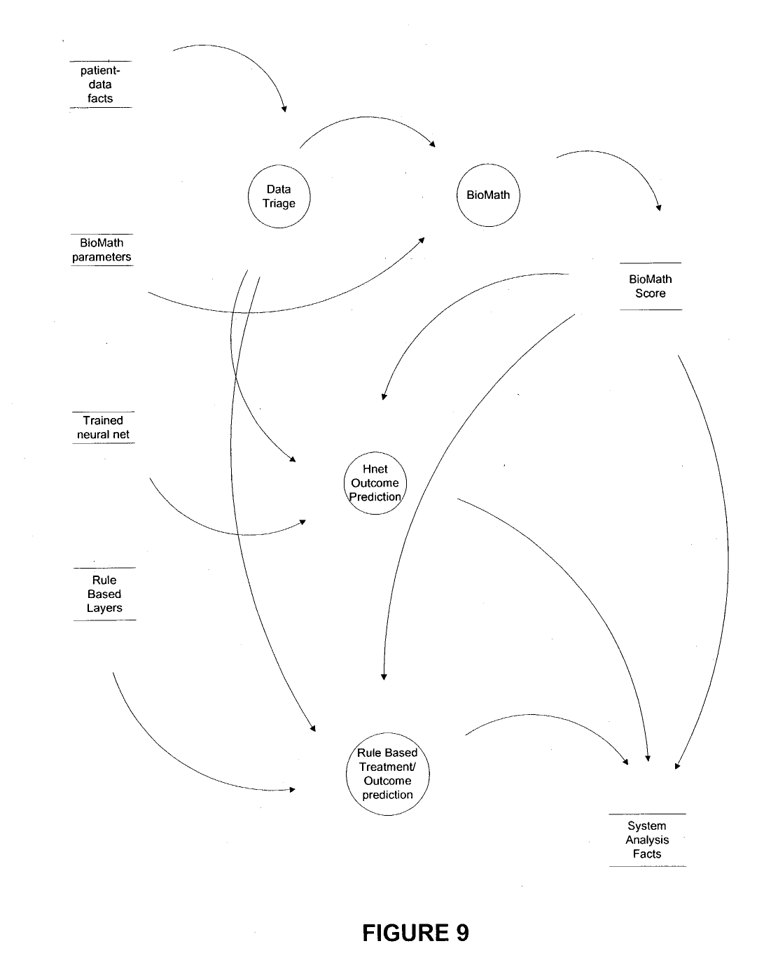

Exemplary system 200 in FIG. 2 for predicting and diagnosing disease behavior includes various components, each to be described in more detail in subsequent FIGS. 3-10. The overall system 200 is divided into two major sections, a development component, and a production component. This layout reflects the fact that the system 200 must first be trained in its analysis, in the development component, before it can perform an individual patient analysis, in the production component.

Whenever new historical patient data is introduced into the system 200, new “training” occurs in the development component. The system 200 then readjusts the specific parameters of its various analysis tools to reflect the new historical data that has been introduced to the system. After such a readjustment, the system 200 is updated to the most currently available disease data, and then performs the most comprehensive individual patient analysis. This most updated analysis is characterized as the best and most current based on the assumption that any historical data added to the system enhances the analytical accuracy of system 200. However, the system 200 could potentially give the client the ability to select from a series of analysis training versions, distinguished by the available historical data and resulting training conducted within the system's development component at a particular point in time. This ability allows the user to conduct comparable analyses over time.

The development component of the system 200 in FIG. 2 relates to the manner in which data is entered into system 200 as historical data, for example, through the External development subsystem (ED); stored, for example, through Analysis Repository (Rd); trained in each analysis tool subsystem of the development component, for example, with biomath (“BM”), Artificial Intelligence (“AI”), Relationship Identification (“RI”); and Rule-based (“RB”); prepared and stored for individual patient analysis; and prepped for actual production analysis (Aₚ).

The production component of the system 200 relates to the manner in which data and analysis requests are received from the client External Production System (Eₚ); stored and organized by individual clinician and patient accounts, though CMS; sent for analysis Aₚ; and recorded and returned to the client, though Customer Management System (CMS) and Ep.

Before each of the components of system 200 is described in detail, the system 200 is considered in greater detail. The system 200 could be selected to have some overall capabilities, such as, for example: provide a tool for diagnosing solid tumor cancer and other diseases based on patient data including genetic markers in addition to patient history and clinical information; function in the form of a service to customers requesting analysis to be run by the company, rather than as a software product for release; provide clinicians with a means for comparing individual patients to a universe of “similar” patients; be designed so that the underlying framework of the system can be replicated for other solid tumor cancers, with colorectal cancer as the first implementation; be designed for use primarily by clinicians with feature functionality applicable to research environments. The above requirements are merely exemplary, and a given system 200 may be designed to have different sets of capabilities.

Each of FIGS. 3-10 further show and describe a particular component of the system 200 shown in FIG. 2. Furthermore, each figure shows the relative position of the featured component of the figure with respect to system 200 in an upper left-hand portion of the figure. Each of the exemplary components in FIGS. 3-10 is further divided into one to three functional layers. In descending order, the functional layers describe the major functions of each component in the particular exemplary embodiment. Other variations and number of functional layers are also possible.

Component Eₚ as shown within system 200 in FIG. 2, and in more detail in FIG. 3, provides access to internal processing environment of system 200 to pre-determined users. One way that such access is provided is through an external interface for users, such as, for example, through a web interface. Eₚ may act as an account data exchange for practitioners and their patients, therefore allowing, for example, request of registration of new accounts, request for enrollment of new patients within accounts, and data collection for additional subsystems. A user may not be able to have direct access to data repositories or analysis systems because of a security wall I1, which will be described in more detail below.

Because the system 200 is designed to be user-friendly, the web interface of Eₚ should provide an intuitive interface that is self instructing, easy to learn, simple to navigate, and provides clear guidelines for use. Security requirements for Eₚ, as with all system components, may be satisfied by communication via SSL with the user's browser. Additional security options include hosting on a physically separate machine, a dedicated LAN, and firewall separation. Other tools are also possible.

Eₚ should collect data for other subsystems in a manner that meets command requirements of I1, which may be satisfied by, for example, using ASP to convert html data to extensible markup language XML efiles. Data validation may be performed to validate (for example, confirm completeness, range, and format) patient data submitted for analysis. Data validation may be performed at the page/form level to provide an appropriate level of user feedback. One example of ensuring data validation is by use of pull down menus, and radio buttons to limit data choices. Another example is by validating XML documents against the document type definition (DTD) before entering CMS. Other methods are also possible. Alternatively, Eₚ should further provide a mechanism for informing a user when data is invalid. Such a mechanism may be addressed through, for example, web page design and functionality, returning error messages from CMS, or the like.

Eₚ further has an Account Data Exchange function, which provides for transfer of requests for new account registration, patient enrollment, and account data additions and modifications for practitioners. Any graphic interface for the Account Data Exchange should preferably have distinct sections for registration, analysis requests, and additions and modifications to account records. The registration section of the Account Data Exchange of subsystem Eₚ should further provide for collection of data related to initial sign-up of new accounts and new patient enrollment and the input of preferences including contact and account information. The Analysis Request function of subsystem Eₚ provides an end user the capability of transmission of requests for information related to analyses, related services and claims. Such analyses include, for example, new analyses, account histories, and client histories. The transaction log of CMS supports these functions. The Account Data Exchange provides for additions and modifications to user accounts and patient records for the purposes of updating account and recording new information on an ongoing basis.

Interface 1 (“I1”) as shown in FIG. 2 acts as a first interface between Eₚ and CMS. I1 may include a limited number of commands common to subsystems CMS and Eₚ in order to allow for consistent but separate development, test, and function of each subsystem. I1 commands include, but are not limited to, get authorization, update account, list patients, add patient, update patient, get patient data, get account transaction, get patient transaction, get transaction, get account data, open account, and delete authorization. I1 further supports data pathways and functions for transactions between Subsystems CMS and Eₚ, allowing collection of data from practitioners through Eₚ and processing of data in CMS. Furthermore, I1 provides an added level of security by separating subsystems CMS and Eₚ. The I1 interface allows external programs (typically a web server) to access the patient database. The patient database contains clinical, pathological, and demographic data about patients. Each patient is associated with an account. The database also contains account information in order to authorize access. The interface supports several types of activities. A first activity includes account functions, such as opening an account, accessing an existing account, updating an existing account. A second function includes patient functions, such as adding a patient to the system, accessing an existing patient, updating an existing patient, requesting an analysis of a patient. A third function includes historical functions, such as requesting a history of account activity, requesting a history of activity for a specific patient, requesting the details of any given activity.

The CMS component serves as the administrative hub between the client (e.g. a clinician requesting analysis for a particular patient), the production analysis subsystem (Aₚ), and the data repository(s), both for the receipt of a request from a client and for the return of an answer or report to the client. CMS is the transaction processing and administrative center of system 200.

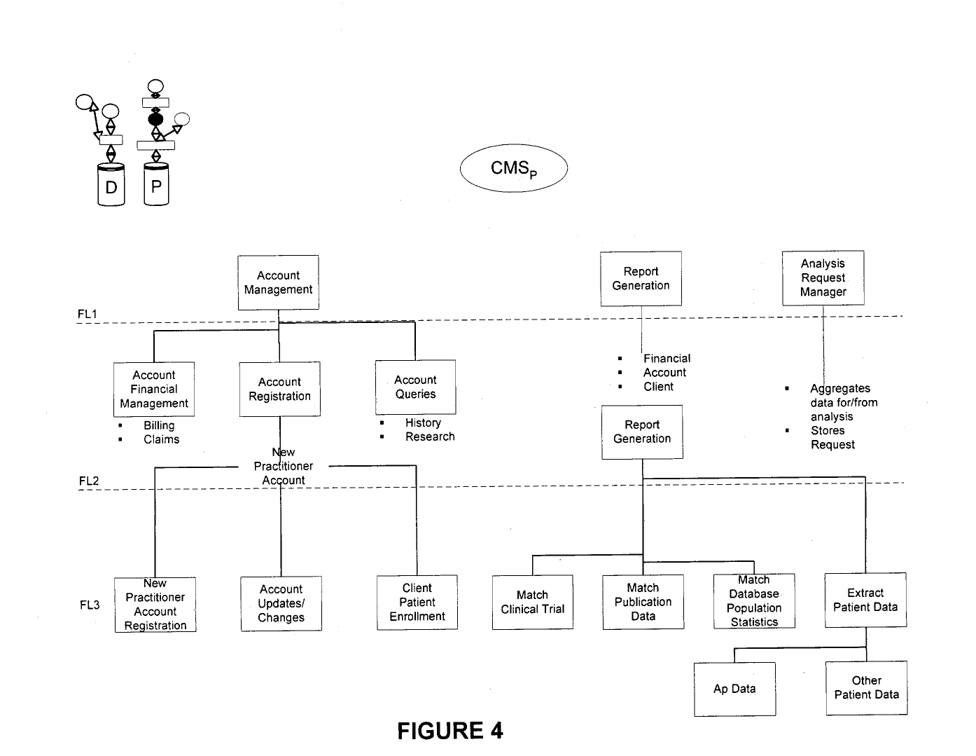

CMS has a number of functions within system 200 as shown in FIG. 2, and more specifically in FIG. 4. For example, CMS is responsible for data collection related to practitioner-accounts and client-patient data from all sources and acts as the repository that stores practitioner account and client-patient data. CMS further manages all interaction/data transactions with the client-patient/practitioner-account database(s) on behalf of all other subsystems. When new data is entered into the system 200, CMS supports the accumulation of patient information at various points and aggregation over time. CMS receives patient data and sends the data to the repository for storage under the appropriate client-patient/Practitioner-account.

When data has been entered and an analysis is requested, CMS produces an output report for each analysis conducted. Such an output report is generated by following several steps, for example: analysis of patient data conducted each time the patient record is updated, output results for each analysis added to the patient record and the existing patient record cached, and data contained in the patient record used to create a report that is retrieved by the user.

CMS further captures basic account information for individualizing the customer and allowing for communication, and record keeping for each customer, including transaction log which provides billing and record keeping capability. Future billing and collection related services information, and a log of all system 200 transactions by patient file or by customer account may also be retrieved. All changes to the database are logged and in the case where changes are made to an account or patient record, the existing record is replaced with the updated record and the previous record is stored.

In its Account Management function, CMS contains an Account/Patient Registration and Authentication function allowing for registration and authentication of practitioner accounts as well as ongoing updates and changes. CMS may further contain an Account Queries function allowing for requests of account information including history of transactions. CMS allows a user to be capable of logging additions/changes to client-patient data by date for the purpose of follow-up and marketing. In certain instances, it may be desirable to establish customer accounts that become the “umbrella” for any individual patient files/analyses/requests.

Under its Report Generation function, CMS allows for generation of reports in response to user requests. As such, several groups of data are coalesced including, but not limited to, patient clinical data, system 200 analysis of data, system 200 terms and conditions, and canned disease specific cancer data/information. The data may take the form of an XML document. The XML document is then converted into the appropriate form, such as, for example, portable document format (PDF), postscript, rich text format (RTF), or others. The Report Generation function allows for collection of all data necessary to respond to user requests.

CMS presents data derived in an analysis including available clinical trials, publication data, and general database population statistics. Further, this allows for comparison and analysis of differences to previous system 200 analyses on the same patient. Report comparison can either be done manually, by human analyst, or automated by matching against the DTD.

The CMS repository supports and enhances a clinician's ability to diagnose and treat cancer. For example, this may be provided in report formatted to contain all possible treatment scenarios produced by the analysis. CMS further contains specific data points related to patient condition, including treatment options and aggressiveness profiles from the bio-math component. Other data that is stored include disease aggressiveness data, optional treatment approaches, treatment effectiveness assessment including probable outcomes under different scenarios, which may be provided by including the predictions generated by the neural network component and the rule based component. A statement of a level of accuracy or completeness may be provided by presenting patient population statistics. CMS may be capable of presenting a comparison outcome with general trends and statistics and include descriptions of clinical trials referenced or related to specific system 200 analysis including trials in process relevant to analysis, and contact/application information related to particular trials.

CMS should be supported by an adequate level of supplemental information and/or services to meet account-practitioners needs including basic educational information limited to supplemental information used in designing an analysis. This is addressed by containing the output of the general cancer information layer of the rule-based component, wherein general cancer information includes general classification, staging, treatment and survival and occurrence statistical information.

CMS conveys patient classification and comparison relative to larger populace of diverse cancer patients in order to give physicians a relative sense of the patient being analyzed as well as the subset of the historical database to which said patient is being compared. CMS will provide minimal bibliographic information to support general cancer information used in designing the analysis.

Another function of CMS is the Analysis Request Manager, which allows for collection and distribution of data related to a request. This function tracks the delivery process from start time and origination to confirmation of delivery/receipt and the path taken. All transactions made within the database and through the interfaces are then recorded. A data sufficiency check may be contained in the CMS to validate patient data submitted for analysis before attempting analysis on the patient and inform the submitter what data values are lacking in lieu of generating a patient diagnosis. Finally, CMS provides validation for the accuracy of outputs.

The CMS design is organized around several principles. A first principle is transaction-based interface. All access to CMS is through a set of interfaces. Accesses through these interfaces are assigned a transaction ID and are logged. The logging function maintains a copy of all data that flows through the interface. Full details of each transaction can be retrieved to support billing functions and requirements of regulatory authorities. The interface will implement the typical transaction attributes of Atomicity, Consistency, Isolation, and Durability (“ACID”). A design principle is that any change to the database, data retrievals that represent “clinical” output to the customer/practitioner, data retrievals that represent “clinical” output to a process that will produce customer/practitioner output, will be tagged and logged by utilizing an interface.

A process that retrieves transaction data for billing functions would not be subject to this constraint.

A second principle includes XML documents. Data that traverses the CMS interfaces is formatted in XML. The specifics of the data, such as, for example, permitted tags, mandatory tags, default values, permitted values, and tag sequencing, will be documented by a set of XML schema documents.

A third principle includes an interface provided for each identified “distinct” user, or “client,” of the system. Distinct means having unique requirements. Thus, clients that have the same access requirements would utilize the same interface.

A fourth principle is that a relational database is used to store and retrieve XML “fragments.” The CMS does not require access to many of the discrete fields in the various XML documents, except when merging two documents for update, which is a function that can be performed without direct involvement of a relational database (“RDBS”). Thus the schema of the CMS database will support the storage and retrieval of the various XML documents in entirety, with a few discrete fields to support indexes as needed.

Some assumptions may be made such as, for example, language-independent availability of XML tools, language-independent availability of SQL interface, and XML-based interfaces provide a wide selection of hardware/software platforms, for both hosting the CMS, and providing client interfaces.

CMS has several functions within system 200. A first function is its Transaction Functionality. The transactional functionality ensures that every change to the clinical data is tagged with a transaction ID and the details of the transaction are recorded in a separate transaction record. Another function of CMS relates to its Database Schema. This schema is designed to store various XML documents, which are documents that generally describe accounts and patients. The XML documents are stored textual data. In order for the XML documents to be accessed in a SQL/RDBS environment, data elements that appear in an SQL “where” clause typically appear as discrete columns. Thus, there will be additional data elements defined to support activities, such as, for example, maintenance of authorization table that includes deletion of stale entries, generation of account IDs, patient Ids, and internal and external crash recovery. Yet another function of CMS is related to Database Queries. There is a general list of the pseudo SQL that perform the database portion of each transaction. Another function of CMS relates to Startup and Maintenance Issues. The usage of typical relational database transaction support capability, for example, a start transaction, a commit transaction, or a rollback transaction will be used to keep the database as consistent as possible. However, because the CMS design maintains its own transaction log, additional consistency checks may be performed, such that the last “n” transactions or sessions can be examined to make sure that the entries in the various tables match up. These consistency checks can be performed whenever the system detects that it is resuming after a probable crash.

As seen in system 200 of FIG. 2, a second interface (“I2”) is positioned between CMS and Aₚ, and contains an Analysis Request Manager function allowing for collection and distribution of data related to a request. Several functions of I2 include, but are not limited to, retrieving single analysis requests from CMS, and retrieving required accompanying data from CMS for analysis. In general, I2 serves to manage, retrieves, and transfer data between the analysis subsystem and CMS. Because CMS is a type of database, I2 provides the functionality related to the database. I2 also serves as a second layer of protection of IMS and various other components of system 200, and may further act as a firewall to protect the integrity of system components. Other functions are also possible. The I2 interface supports internal analysis functions. It allows an analysis program to retrieve the clinical, pathological, and demographic data associated with a given patient, and insert into the database the results of an analysis for a given patient.

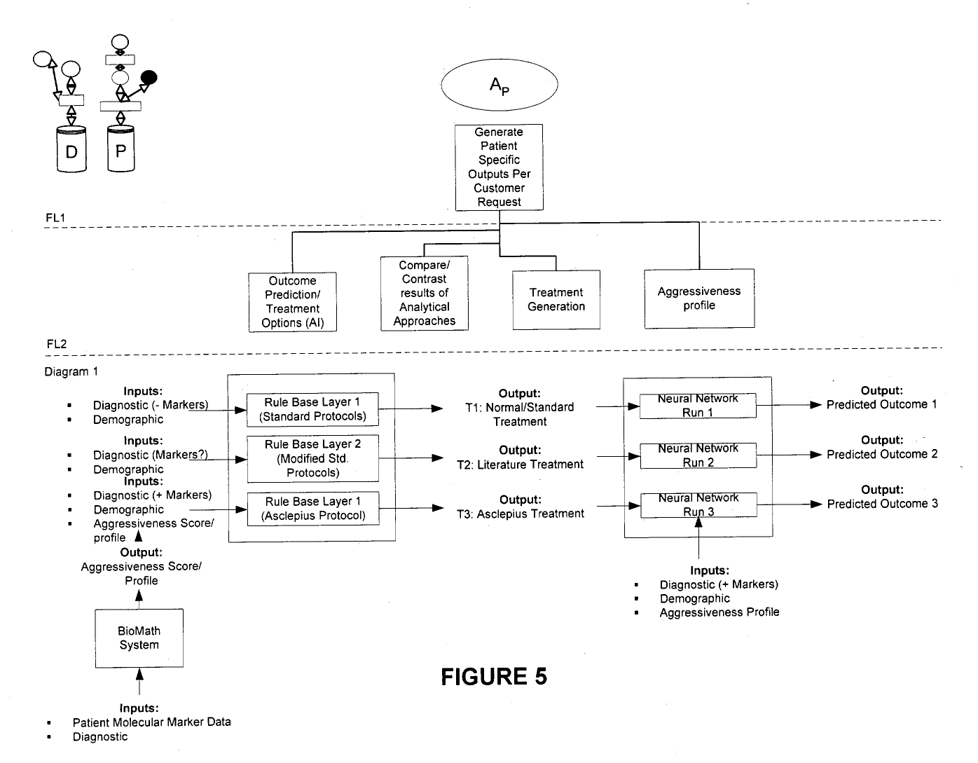

As shown in system 200 of FIG. 2, and in more detail in FIG. 5, an analysis production component is labeled as Aₚ. The Aₚ component is the analysis system composed of the analysis modules used specifically for conducting an analysis transaction request from a client, such as a clinician, for a specific individual patient. Historical data that is run through A_{d} subsequently trains A_{d} in order to produce an analysis tool version specific to the historical data at that time that manifests as Aₚ.

More specifically, Aₚ should provide a high level of detail and accuracy in patient diagnostic and treatment recommendations to clinicians. One way of doing this function would be to correlate relationships identified in historic patient records to any similar findings in a client patient record submitted for analysis. This may be carried out by use of the rule-based system and the neural network, as described herein. Other methods are also possible. Another function of Aₚ is to identify the most effective treatments based on confirmed relationships and related treatment effectiveness data. Again, the rule-based system is one exemplary way of performing this function.

Aₚ performs patient classification and comparisons relative to a larger populace of diverse patients in order to give clinicians a relative sense of the patient being analyzed as well as the subset of the historical database to which said patient is being compared. One way that this is performed is through generating historical patient population statistics in A_{D}. If a rule does not exist for a particular new patient, then that patient may be considered an outlier and no output will be given. Standard statistical analysis, such as regression analysis, on the historical patient data may be performed to identify patient groupings, and what would be considered as outliers.

A unique function of Aₚ is to generate patient-specific outputs per request. Such outputs contain, for example, an Analysis Output function allowing for multiple outcome predictions and related treatment options, and the generation of a patient-specific aggressiveness profile, such as aggressiveness scores developed by the bio-math component. A user of system 200 further receives an Analysis Output function allowing for comparing and contrasting of analytical approaches and an Analysis Output function allowing for generation of treatment options. Further, the output predicts disease course of progression and projected disease timetable specific to the client-patient being analyzed and produces individual patient aggressiveness scores related to disease progression. Upon receiving and considering all such output information, from Aₚ, the clinician then determines the best route for treatment.

Aₚ should follow a consistent, logically structured rule set for conducting and reporting analysis and provide data to CMS which will include information on levels of analysis conducted based on portions of the rule set actually used. All rule-based layers capable of producing outputs should report outputs. Other data is forwarded to CMS which will include information on system 200 database statistical reference points, such as, for example, total size of database and database subset used for the analysis, number of patients used in a particular comparison/analysis, and general database performance parameters. Finally, Aₚ allows collection of information for temporal validation of client-patient data by a human analyst, including checking to ensure the data is valid, e.g., makes sense, is non-conflicting, and relates to the correct patient.

The Aₚ process applies the data modeling and analysis algorithms developed during the system 200 development process to a data set representing a single patient. This process is referred to as patient analysis. The process has the following steps: a patient data set is retrieved from the CMS (Customer Management System) when a analysis is requested, the data set is analyzed for completeness and the appropriate analysis routines are scheduled, each scheduled analysis routine is executed, and the results of the analysis is aggregated and returned to CMS for storage.

A consideration to be made about the analysis development phase is that the data requirements and analysis/modeling techniques selected by the development phase will change over time, therefore requiring flexibility in the organization of the production analysis phase. This flexibility will be provided by a documented interface into which new or altered analysis modules can be added to the system with minimal impact.

Inputs to the Aₚ include an XML document that represents the aggregation of the patient data received at the time of an analysis request. It consists of several sub documents (that are retrieved from CMS upon request) that may include, but are not limited to, patient-demographics and patient diagnostics. The patient identification document is not made available to analysis routines in order to maximize patient privacy.

Other possible inputs into Aₚ include HNET assemblies, which are a set of trained neural nets that classify a patient into a specific “outcome,” and are typically in HNET file format; standard treatment protocol rules, which is a production system representation of the decision tree associated with the treatment of colon cancer, and is typically in C Language Integrated Production System (CLIPS) code; clinical trial matching rules, which are a production system representation of the rules for entering a given trial and are one set of rules per trial, and typically in CLIPS code; clinical trial details, which are the details of a given trial in a canonical XML format so the trial can be presented via HTML or paper format; cancer information matching rules, which is a production system representation of the matching rules of colon cancer information that is specific to the stage of the disease or condition of the patient, for example, stage IV cancer, recurrent cancer, etc., and typically in CLIPS code; Analysis rules, which is a production system representation of the relationships discovered by the development, which is in CLIPS code.

The output of Aₚ may include, but is not limited to, patient-analysis, which is an XML document that contains the results of the data triage and scheduling analysis. These results are always generated. The results of the individual analysis are available if scheduled and performed, although they may be dependent on intermediate results as well. Other output may include: bio math aggressiveness index, HNET outcome prediction, system rule set derived treatment and outcome prediction, statistical relation of current patient to historical database, standard treatment for this patient, clinical trial applicability and ranking, and disease specific information.

The processing of Aₚ includes: (1) Data Triage and Analysis Scheduling, which process performs all the housekeeping for the analysis system. It compares the current patient data set against the data requirements of each analysis module to determine the “schedulable” modules, builds a “job schedule” data structure ordering the “schedulable” modules taking into account the precedence of the modules and dependence on intermediate results, and processes the “job schedule,” executing modules as appropriate and preserving intermediate results, aggregate the intermediate results into a patientanalysis document that is stored back into CMS. (2) Bio-math processes. (3) HNET Outcome Prediction contains a list of runs against a set of training sets is passed in, for each run, a vector of data to be compared against the trained net is prepared, each vector is run against the trained net, the prediction of each run is returned. For example, the neural network may be an assembly that is trained with a given set of data and may be designed to predict the life expectancy of a given patient. Other predictors, such as treatment options or other related predictors, may also be possible.

The functions of the following components of the rule-based module are very similar and they differ only in their data requirements and which “rules” file they load. One component is System-derived Treatment and Outcome , a CLIPS “facts” file identification built from the patient data. The CLIPS treatment rules file is loaded into the inference engine, the CLIPS “facts” file is loaded into the inference engine, the inference engine runs, the results are logged to a file, the contents of the results file is returned. Another component is Standard Treatment, a CLIPS “facts” file id built from the patient data, the CLIPS standard treatment rules file is loaded into the inference engine, the CLIPS “facts” file is loaded into the inference engine, the inference engine runs, and the results are logged to a file, the contents of the results file is returned. Yet another component is Clinical Trial Matching, a CLIPS “facts” file id built from the patient data, the CLIPS clinical trials rules file is loaded into the inference engine, the CLIPS “facts” file is loaded into the inference engine, the inference engine runs—the results are logged to a file, the contents of the results file is returned. Another component is Cancer Information Matching, a CLIPS “facts” file is built from the patient data, the CLIPS cancer information matching rules file is loaded into the inference engine, the CLIPS “facts” file is loaded into the inference engine, the inference engine runs—the results are logged to a file, the contents of the results file is returned.

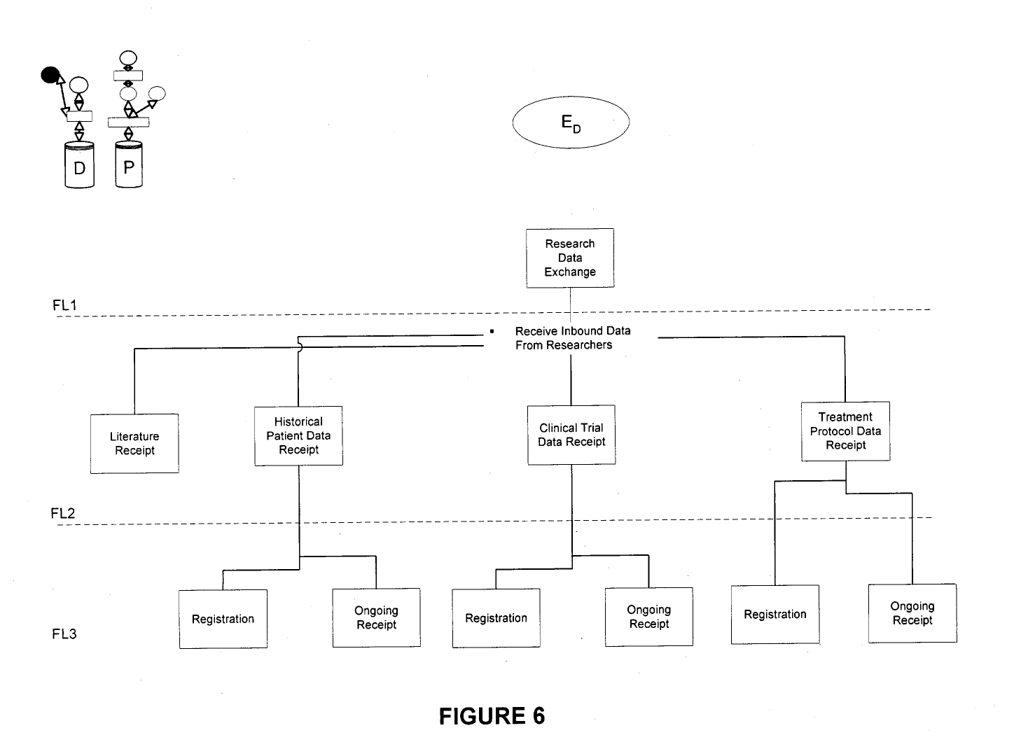

As shown in system 200 of FIG. 2 and in more detail in FIG. 6, External Development System (E_{D}) is the development component's equivalent of Eₚ. E_{D} receives inbound data from researchers and data sources and incorporates such data into its development data bank. Such data relates to, for example, the demographic, test results, and marker results, of various patients that all have a certain medical condition, such as, for example, colon cancer. Data received in this component is not limited to a single source, but may be derived from literature, historical patient data, clinical trial data, and specific treatment protocol data. Other sources of data are also possible.

As shown in system 200 of FIG. 2 and in more detail in FIG. 7, the Analysis Development component (A_{D}) is the portion of the system 200 that receives historical patient data and then uses this data to train the analytical components of the system 200 to both reflect the information brought by the new historical data and enhance the analysis framework and historical data already in the system at any point in time. The functions of A_{D} reflect that the system 200 will continually expand and adapt to the input of new historical patient data. The greater the volume and quality of the historical patient data available for analysis, the better the predictive ability of the system 200 in generating diagnosis and treatment information for any individual patient.

The analysis framework of A_{D}, which includes the bio-math, artificial intelligence, statistical, rule-based and other analytical tools, may change in its framework or flow as new data is entered into the system. Thus, the “production” formats of the analytical components that are actually used to analyze an individual patient may change.

A_{D} provides five different exemplary analytical methods that could be used to analyze both historical data, for the purpose of training the production analysis subsystem, and individual patient data, for generating diagnosis and treatment information. The four analytical methods are intended to reflect a range of analyses that perform the following: model patient data in a manner that reflects the biology of the disease, evaluate data in a manner that follows or incorporates standard and accepted statistical methods and measures for understanding disease, evaluate data in a manner that follows or incorporates standard and accepted rules for diagnosing and treating disease, and identify unique and perhaps previously unknown relationships within the data that impact the disease progression. Other functions are also possible.

System 200 is designed to be flexible such that the actual nature and number of analytical methods employed within it can change over time to more fully reflect these and other analytical goals. For example, several general analytical goals and specific analytical tool solutions that could meet those goals include: CRUISE (Classification Rule with Unbiased Interaction Selection and Estimation), a specific analytical tool for identifying relationships in the data; Conventional Statistical Analysis, which reflects the current accepted analytical measures used for assessing disease data; Artificial Neural Network, which reflects a specific ANN software tool (HNet) that is used to predict patterns in patient data; Rule-based System, which refers to a rule-based analytical tool, based on a specific rule set, that runs data against both standard diagnostic and treatment rules, as well as new data rules/relationships that are discovered in the data during analysis.

A_{D} generally requires sufficient historical patient records of a specified completeness so as to render individual analysis results statistically significant and valid. A_{D} further provides validation of the significance of identified relationships by correlating patterns with scientific/medical principles. Finally, A_{D} generally allows for input and storage of relationship derived rules emerging from system 200 related analysis and research, either internally or resulting directly from partnered work.

A_{D} has a Generate Production Predictive Tools function that contains a function allowing for the creation of a production-ready predictive tool for use in Ap. This is accomplished by creating assemblies and configurations using historical patient records. This function of A_{D} also needs sufficient treatment and outcome data within the historical patient records so as to render predictive components statistically significant, and to accurately predict disease course of progression and projected disease timetable.

Another function of A_{D} is a Generate Production “Biomath” System, which allows for the creation of a production-ready bio-math system for use in Aₚ. One way this may be accomplished is through development of the bio-math component. This function of A_{D} predicts disease course of progression and projected disease timetable by identifying the most probable pathway of the patient markers. It further provides a means for producing individual patient aggressiveness scores related to disease progression by identifying the most probable pathway of the patient markers.

Another function of A_{D} is its Generate Production Rule Set Layers function, which allows for the creation of a production-ready rule set for use in Aₚ by creating the rule based layers containing rules related to system 200 derived relationships, standard treatment protocols, available clinical trials, and general cancer information. This function follows industry acceptable and traceable methods for analysis by presenting the rules in a familiar decision tree format. A_{D} follows a consistent, logically structured rule set for conducting and reporting analysis by presenting the rules in a familiar decision tree format. It further identifies significant data fields within patient diagnostic, demographic, and treatment data that affect patient diagnosis by using CRUISE and other statistical packages. Any relationships within the historical patient records are discovered and further correlates to any similar findings in a client patient record submitted for analysis. An analyst could confirm scientific validity, and the Rule based system will apply the relationships in analyzing new patients. Multiple analysis approaches may be used in identifying and analyzing relationships during research and development through use of CRUISE or other statistical packages.

The most effective treatment based on confirmed relationships and related treatment effectiveness data are presented by A_{D}, which will further compare and contrast methods used in identifying relationships in order to validate relationships. Finally, A_{D} could identify data fields with the most significant bearing on predicting course of disease progression, as determined by statistical analysis.

From a more detailed functional perspective, A_{D} is designed to generate and test analysis tools to be used in the Analysis Production subsystem One such analysis tool is the Rule Based System, which implements facts identified in historical patient records and represents them in a decision tree format. The facts of the Rule based System are identified in the development phase by a series of tools intended to analyze the data to identify relationships and patterns affecting patient treatment and survival. Currently, the relationship identification tools include a data miner, for example, CRUISE, and conventional statistical software packages. The remaining pieces of the Analysis Development subsystem include analysis tools ‘trained’ and/or tested in the development phase in preparation for use in the production phase including the bio-math system and an artificial neural network.

CRUISE outputs a classification tree and information related to the nodes of that tree. A user then analyzes the tree to determine significant relationships. The user must translate the significant relationships within the tree into “If/Then” statements that can be coded into the rule based decision tree.

Various methods may be used to test the data for basic logic/validity. Such analysis methods include, for example: regressions and trend identification; visual/graphical representation; identification of data groupings; layered testing of hypothesis; T-test, un-Paired which is comparing of the same variable between two groups, and Paired, which is comparison of same variable at two points in time for same group; analysis of variance (“ANOVA”), comparison of subgroups of dataset, comparison of same variable; co-variant analysis, showing impact of multiple variables simultaneously, and requires a weighted analysis or prioritization; and ROC Curves, which are used for prediction, sensitivity and specificity.

The desired output for conventional statistical analysis may be determined by a user. A human analyst will be required to analyze the outputs and develop “If/then” statements that can be coded into the rule based decision tree

In an Artificial Neural Network analysis, the same data input is needed as the conventional statistical analysis. However, the data will be organized and coded according to type of input including categorical, dichotomous, and continuous variables. Data must be filtered with predetermined inclusion/exclusion criteria of data fields. Various partitioning strategies will be utilized to determine which fields will be stimuli and response as well as to divide the dataset into training and validation sets

Using an HNET Development process, cell assemblies are constructed for HNET, cell assemblies are trained using the filtered and partitioned data, and a self validation is run. The assembly is run against the stimuli in the validation set to determine if the assembly accurately predicts response, and useful assemblies are stored along with the related configurations so the assemblies can be used on new patients. The output of HNET includes assemblies and configurations that will be used in predicting outcome in new patients.

In a Rule Based System, the inputs include confirmed “if/then” statements identified by CRUISE and other Statistical analyses, standard protocols from published literature, clinical trial information, and general cancer information from published literature.

In developing a Tree Layer construction, the above methods are used to develop four rule base layers: The confirmed “if/then” statements generated by CRUISE and the statistical software are coded to form the system 200 layer of the rule based tree(s). The standard protocols from published literature is converted to multiple “if/then” statements and coded into the standard protocol layer of the rule-based tree(s). The general cancer information from published literature will be converted to multiple “if/then” statements and coded into the general cancer information layer of the rule-based tree(s). The clinical trial information from open clinical trials will be converted to “if/then” statements and coded into the standard protocol layer of the rule based tree(s)

The output of this system includes a functional rule based system that will take in new patient records and recommend an individualized treatment with the probability of the best possible outcome or that is based on the standard protocol. In addition, the functional Rule Base will match the current patient to available clinical trials.

For use of bio-math, the input includes, for example, immunohistochemistry values for selected markers from historical patient recordsThe output is a functional bio-math system to be used in the Analysis Production system.

As shown in system 200 of FIG. 2, a Client Account Data Repository Rₚ provides storage, structure and appropriate interfacing for client-patient and practitioner-account data by CMS repository schema and the storage of XML records for client-patients and account-practitioners. New patient records should contain diagnostic and demographic data and treatment and outcome data where available by requiring entry of such data on the web interface Eₚ. Such new patient diagnostic data contains information relating to, for example, TNM staging, tumor differentiation, tumor type, tumor size, tumor location, specified markers and available additional markers, clinical laboratory results, and additional pathology data. Such data may be required to be entered on the web interface. New patient demographic data could include, for example, year of birth, sex, ethnicity or race, and available family and medical history, social and education history, and geographic data. Such data may be entered on the web interface.

New patient treatment data should include, for example, age at surgery, type of surgery, any adjuvant therapy received and available complete treatment timeline. New patient outcome data should include, for example, available data related to tumor recurrence, vital status, follow-up timeline, cause of death and available recurrence timeline.

Eₚ would provide storage of data supported by appropriate data security by communication via SSL with a client's browser. Additional security options include, but are not limited to, hosting on a physically separate machine, a dedicated LAN, and firewall separation. Archival functions are also provided by logging all changes to the database and by caching all modified records.

As shown for system 200 in FIG. 2, a Research and Development Data Repository (“R_{D}”) provides storage, structure, and appropriate interfacing for all nonclient/practitioner data necessary to develop and support the production subsystems. This component may also tag historical patient data by source so that analysis can include and exclude data. A tracking mechanism may also be provided for tracking system 200 formatted data format back to the original data. RD allows for data input from a number of sources, including historical patient records from internal and external sources by manual input of historical patient records into the repository. For example, R_{D} receives input of data related to ongoing clinical trials including contact information, acceptance criteria and other general information, which may be submitted by manual input of active clinical trial data into the repository, input of treatment protocol data from medical organizations and societies, or input of historic patient data from varied sources including qualified research laboratories and company sponsored research laboratories.

R_{D} contains historical patient diagnostic data, such as that relating to TNM staging, tumor differentiation, tumor type, tumor size, tumor location, specified markers and available additional markers, clinical laboratory results, and additional pathology data. Historical patient demographic data is also contained, and which includes, for example, year of birth, sex, ethnicity or race, and available family and medical history, social and education history, and geographic data. Further information that may be contained include historical patient treatment data including age at surgery, type of surgery, any adjuvant therapy received and available complete treatment timeline, where tissue samples are archived, and/or diagnostic data in terms of digitized diagnostic images.

Historical patient outcome data is also contained in R_{D}. Such outcome data includes, for example, tumor recurrence, vital status, follow-up timeline, cause of death and available recurrence timeline. Other external data is also stored, such as accepted treatment protocols listed according to the agency or association recommending the treatment protocol, and widely accepted facts and information, or sources of information, about a disease, such as colon cancer. General stored cancer information includes general classification, staging, treatment and survival and occurrence statistical information.

The overall system 200 shown in FIG. 2 contains support and security across the production and development subsystems. Additional security options include hosting on a physically separate machine, a dedicated LAN, and firewall separation. System 200 may also provide an evaluation and report of any analysis processing performance on all levels including physical technology, analysis methodology, and analysis output usefulness, and be able to track the analysis process for each record from origination to completion.

The system 200 is designed to maintain patient confidentiality by adhering to government standards on patient confidentiality, and provides security for databases to ensure data integrity and privacy. Further security measures include auditable security measures for the entire system which may be implemented by spot checks and software quality assurance measures. Further guards are provided to prevent unauthorized changes to system or system code. Only authorized users may have access to the system 200, thereby maintaining a secure system.

Although the system 200 is designed to be flexible to conform to the specific protocols of a given medical problem, several system constraints and performance requirements may be suitable. For example, the system 200 should be able to receive customer inputs and return requested information in real time; perform input validation in real time; determine patient treatment recommendations within minutes of receiving patient records; generate the output report within minutes of patient record receipt; retrieve the output report in real time upon customer request; and multiple analyses, for example, five, per hour.

The bio-math component is a calculation-intensive part of the system 200. To fully understand the reasoning and theory used to develop bio-math, a brief background is needed. Because a goal of system 200 is to predict and diagnose disease, it is primarily reliant on the molecular biology of disease in the manner in which it analyzes and provides support to the diagnosis, prediction and treatment of disease. This biological underpinning is anchored heavily in the protein processes and the existence and interaction of protein and genetic markers in individual patients.

Diseases often have common indicators that provide signals as to the existence and progression of disease. Often these indicators, such as protein concentrations, can be quantitatively represented and evaluated to determine proper (normal) and improper (diseased) function. The bio-math component of the system 200 analysis is an important component in attempting to offer insight into disease progression and in both interpreting common disease indicators and generating additional indicators that help to provide a more complete picture to clinicians as to the characteristics of disease.

Although described in detail with respect to cancer, the system 200 has been designed to have applications across many diseases. However, cancer (and specifically colon cancer) serves as a good example of how clinicians currently measure and monitor disease and how the bio-math portion of the system 200 will seek to enhance current practice. The medical industry currently has two standard indices it uses to describe the severity of cancer. These indices include tumor grading and TNM staging. These descriptive indices in part and in combination give the clinician and the patient an idea of the severity of the disease at any one point in time (marked by a surgery) in its staging. These indices do not however reflect a complete description of the path the cancer is taking in a particular patient or the pace of progression of the cancer.

The bio-math component of the system 200 seeks to go beyond the common indicators of disease, such as grading and TNM in cancer. The bio-math component delivers a quantitative score describing the aggressiveness of a disease, such as, for example, cancer, based upon protein markers identified from a tumor specific to the patient being analyzed. The bio-math analysis is designed not only to describe the current state of the disease, but also the probable path going forward based on the molecular makeup and pathways of the particular patient. Current indices, such as the TNM staging in cancer, would be insufficient to predict such individualized outputs. The bio-math component then provides a more complete view of the path of a disease as well as the pace or aggressiveness of the disease along that path. For example, two patients with the same TNM stage but different protein marker profile could be run through the bio-math analysis to determine if either profile is consistent with a higher risk of recurrence or metastasis. In doing so, the bio-math component also delivers an individualized score for each patient that offers the clinician both insights as to how to most effectively treat that patient as well as a comparable data point against other patients.

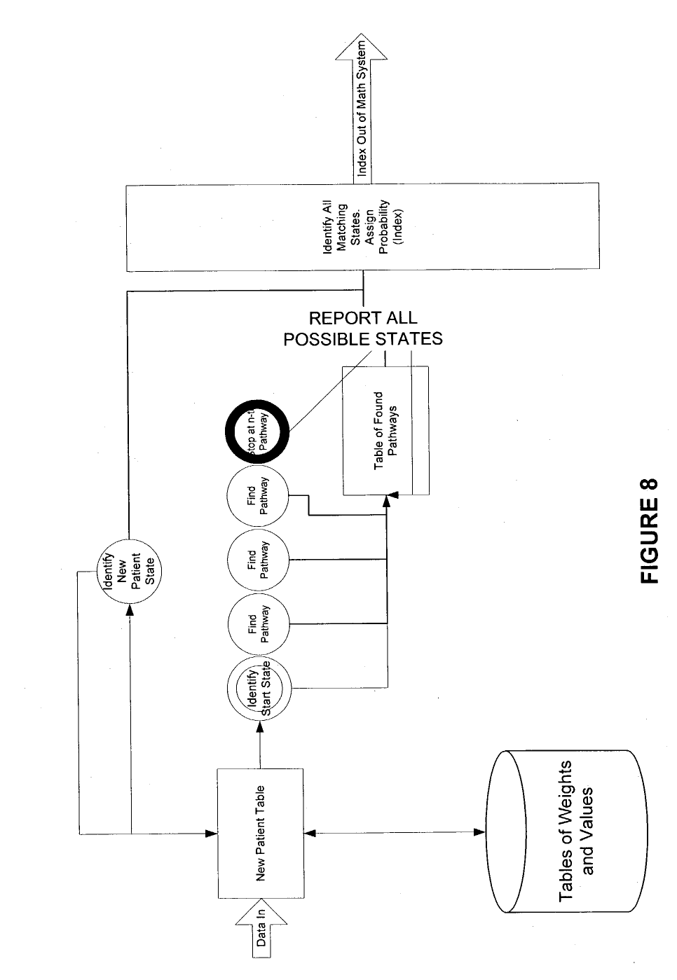

As shown in FIG. 8, the bio-math component of system 200 targets several outcomes in its analysis. Such outcomes include, but are not limited to: give the clinician and patient a description of the molecular pathway that their disease is and will likely continue to follow; offer a measure of the pace or aggressiveness of the disease within the patient; and highlight the molecular factors (primarily but not exclusively protein concentrations and interactions) that are impacting both the path and the pace of the disease.

The bio-math component operates initially in a modeling mode in the Development portion of the system (A_{D}). In this mode, historical data is run through several bio-math algorithm(s) in order to produce: a table of weights and values from the historical molecular patient data; a table of known pathways that the disease can take; an indicator of the aggressiveness of disease along a pathway given its weights and values in a particular patient with a specified pathway.

The general steps in the process that the bio-math analysis follows in A_{D} are as follows: Several patients are selected that have all the desired fields present (markers), and the data on these patients is then run through the algorithm(s) repeatedly and adjustments are made to the weighting given to each marker concentration level that represents the molecular interaction and pathway until a logical and known biological pathway can be patterned and confirmed. The weight is intended to specify the influence a particular concentration has in deciding which molecular pathway occurs within a cell.

Once a pathway and its related weights and marker values are determined from the initial patient selections, other patient data is analyzed using the same pathways, weights and value. When a consistent result is produced, the data population is expanded and moved forward in a series of levels of confirmation. Where pathways and weights are not matched or confirmed, the analysis process returns to the starting point where pathways and/or weights are readjusted.

Ultimately, a specific pathway is defined in correlation with certain markers and weights. This process reflects known data as well as projected data that indicates the continued course of the disease progression path. This process is repeated for different values of markers and different patients in order to generate a table of weights and values against which new patients can be mapped. A table of known pathways is also generated which provides the same predictive capability for patients relative to disease path. By analyzing historic data for patients for whom there is known outcome data, the bio-math analysis develops a certain predictive capability as well as an indication of the aggressiveness of the disease.

Referring to FIG. 8, bio-math receives input in the form of biological markers, which may be, for example, p53, Cyclin D, p21, or others. The markers will be delivered via outside system CMS as integers. These values will be stored in active memory in the New Patient Data Table. CMS will also deliver an identifier that will be a unique alphanumeric set that will identify the patient.

In the bio-math component, weights of interaction are described in a Table of Weights and Values as decimal numbers within the range of 2.0 and −2.0 that describe the kinetics of the interactions in the bio-math algorithms. These weights will be determined manually previous to execution of the algorithms in the R_{D} system. Each interaction will have it own descriptive weight. For example, Cyclin D promoting pRb is one interaction. These weights will be stored in semi-permanent memory in the structure of a matrix.

A new patient table will store numeric data in active memory only. This table identifies all delivered and generated data under the alphanumeric identifier described in the Data In section. The data will be stored as a matrix. The only function of this table is to identify the markers that where delivered by Data In and call for the weights associated with each marker's interaction. The weights can then be delivered and distributed onto a matrix that maps positions of weights with interactions using the following technique K_{IJ}, where i represents the beneficiary of the interaction and j executes the interaction. The terms i and j are integers that are associate with a biomarker. The number of i and j terms are limited only by the number interactions a particular biomarker will have.

Identifying the Start State is the first function the execution of the bio-math algorithm. The data stored in the new patient table is delivered to the algorithm. The algorithm will then begin running to produce states. One of the states will be identified and the start state. The start state is the earliest set of interactions (state) that can occur with in the cell. These states are determined by a numeric identifier that is attached to each possible state that represents that state's place in the progression of the cell cycle.

Find pathway is the second function of the bio-math algorithm. Using the start state as the first state in a possible pathway, the algorithm then runs through all possibilities for the purpose of determining all the possible paths of progression. At least two types of pathways exist: terminal pathways are pathways with n states that reach a terminal single steady state that ends the pathway; and loop pathways are pathways with n states that reach a continuous loop that never terminates but must repeat.

All of the possible pathways are reported to the Table of Found Pathways. The table of found pathways is a matrix that is stored in active memory only. The pathways will be identified with the same unique alphanumeric identifier discussed in the data section. All possible states will then be reported to the Identify All Matching States system.

A first function of Identify new Patient State is to call for the marker values from the New Patient Table. The second function is to convert the marker values from integers in the range of negative infinity to positive infinity. To a sent of integers from zero to n, n being the highest possible level of protein. The algorithm uses the zero to n format, which is purpose of this conversation. This new set of values will be the current state of the patient. This state is reported to the Identify All Matching States system.

The Identify All Matching states system will compare the states in the found pathways (from Table of Found Pathways) with the new patients current state (from Identify New Patient State) and remove all states that do not contain the new patient state. The system will count the number of the states following the new patient state and multiply that number by the sum of the weights of the states (each possible state will be assigned a weight, the weight represents the likelihood of that state existence; the weights will be in decimal format with an unknown range with the highest number representing the state least likely to exist). The five pathways with the lowest number will be arranged in ascending order and reported to the CMS system.

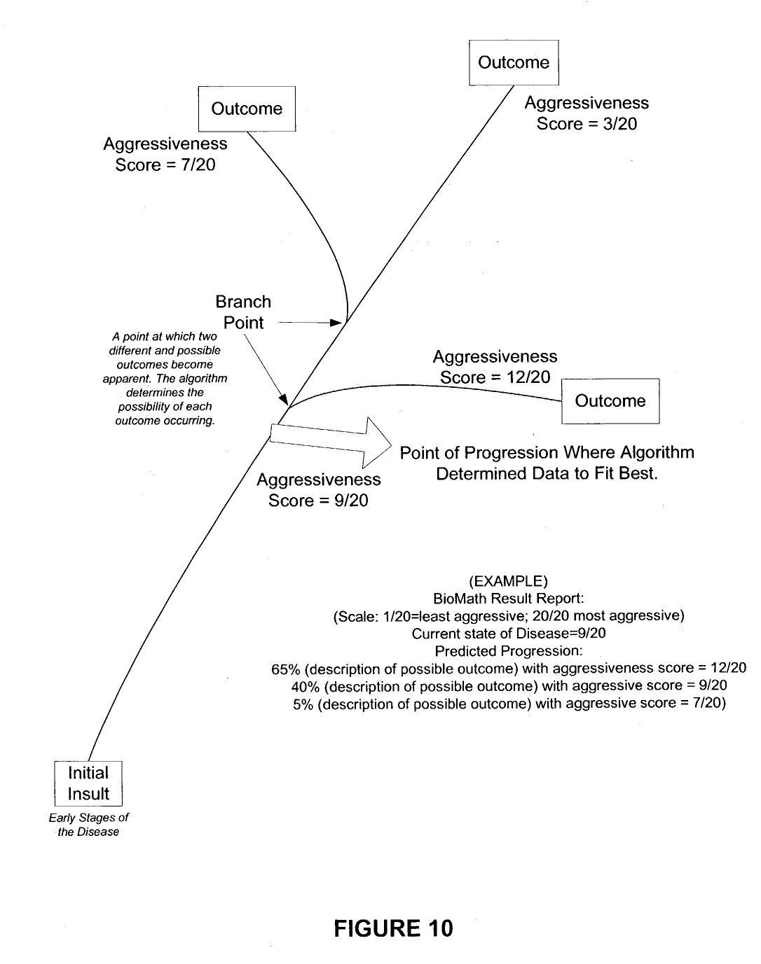

FIG. 10 shows an example of a tree representing a complex of aggressiveness scores for a given disease. Although the particular example is shown having a unique geometry, the invention is not limited to such a tree design or geometry, which is dependent on the particular disease and its related number of unique variables and outcomes. Several arbitrary outcomes have been shown in the figure, each such outcome is a known end result of the disease as determined by research studies or experience. For example, the outcomes for the exemplary disease tree shown in the figure may be based on a five-year study of other patients with the same disease, and in the case of cancer, could include death, false remission and recurrence, metastasis to other organs, death due to complications of the disease, or survival. Other outcomes are also possible.

The tree diagram for a given disease as shown in FIG. 10 is based on data that has been collected and mapped out according to bio-math, as described above, or other mathematical analysis techniques. When such a tree diagram is developed through background data, any subsequent patient data is compared with the prior data structure and then placed somewhere on the tree diagram. Such a spot on the disease tree correlates with an aggressiveness score for the particular patient being analyzed. Thus, bio-math determines where a patient's profile best fits in the pathway. Furthermore, dependent on the patient's unique profile, bio-math further simulates disease progression to determine which branch points on the disease tree is most likely to fit the patient's profile. The results of the bio-math analysis and aggressiveness score placement for a particular patient is then reported to CMS in a format that projects a statistical likelihood of disease progression, such as that exemplary format shown in FIG. 10.

The systems and methods according to the present invention have numerous advantages that enable more comprehensive and reliable consideration of disease behavior. An advantage is the flexibility of the present invention, enabling users to develop models that are adaptable to different sets of data and different diseases. It is not limited to one set of data or a single disease. Further, a focus of the present system is in developing models that focus on biological events and interactions in predicting and diagnosing disease, such that the analytical methodology is a reflection of the natural biological events. A strong emphasis on biological markers is one way that the present invention is more reflective of the true physiological events that signal, indicate, or relate to a diseased condition. Solutions that are developed using the present invention use multiple layers and points of analysis to reflect many factors that impact disease. A system of checks and balances further validates the solutions. A further advantage is the consolidation of disparate data sets and a method of standardizing such data sets to develop a comprehensive single data set from which to draw epidemiological patterns.

Other advantages of the system include its ability to model disease at various stages throughout the cycle of the disease. Thus, the system is not limited to diagnosis at specific points of a disease life cycle. Furthermore, the system has the advantage of allowing analysis between different states of a given disease cycle so that a user may identify how a disease has progressed in time.

A clinic or other health care institution may benefit greatly from use of the systems or methods according to the present invention through an in-house computer or software program. The greater use of technology will aid such organizations greatly in diagnosing and treating disease. Alternatively, such a tool may become standardized throughout the healthcare industry and be connectable through ubiquitous means, such as the Internet, and run off a remote server. Thus, as long as a health care worker has access to the Internet, such worker will have access to the most comprehensive system in diagnosing and treating disease. Health care workers in remote areas, such as in isolated regions of the world without landlines, may still have access to such a powerful tool through wireless connection devices, such as personal data assistants (“PDAs”, portable computers, or the like.

In describing representative embodiments of the invention, the specification may have presented the method and/or process of the invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the invention should not be limited to the performance of their steps in the order written, and one skilled in the art can readily appreciate that the sequences may be varied and still remain within the spirit and scope of the invention.

The foregoing disclosure of the embodiments of the invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

What we claim is:

1. A system for using a database of patient data to simulate disease progression and identify relationships affecting disease treatment and outcome by analyzing patient specific data in the context of historical data, the system comprising:
a database of historical patient data;
a system for receiving patient specific data; and
a computer system programmed to:
receive patient specific information;
identify and retrieve relevant historical patient data;
analyze the patient specific information with respect to the relevant historical patient data; and
output information as to the patient's likely response to treatment protocols or suggested treatment options based on the analysis of the patient specific information with respect to the relevant historical patient data.

2. The system of claim 1, further comprising:
an indicator to prompt a user to provide specific information or conduct specific tests.

3. The system of claim 1, wherein the information output is in digital format.

4. The system of claim 1, wherein the system includes a biomath module for providing a mathematical representation of a biological system.

5. The system of claim 4, wherein the biomath module produces an aggressiveness index and/or individual aggressiveness scores for patients.

6. The system of claim 4, wherein the biomath module mathematically models molecular mechanisms.

7. The system of claim 1, wherein the system includes an intelligent system module for disease progression and outcome prediction.

8. The system of claim 7, wherein the system that includes the intelligent system module provides a prognosis for outcome and/or treatments based on non-linear analysis.

9. The system of claim 1, wherein the system includes a statistical module for identifications of relationship in data.

10. The system of claim 9, wherein the statistical module performs medical metrics and seeks to validate output of other modules.

11. The system of claim 1, wherein the system includes a rule based module for providing analysis protocol for diagnosis and treatment.

12. The system of claim 11, wherein the rule based module analyzes data through a complete ruling of standard protocol and compares and contrasts all module analysis outputs.

13. The system of claim 1, further comprising means for standardizing the data collected and updating the patient database.

14. The system of claim 13, further comprising means for prompting users to input data used to update the database after a predetermined time period has expired.

15. The system of claim 1, wherein the computer system is accessible through the Internet.

16. The system of claim 1, wherein the computer system is portable and enables a user to use the system at any location.

17. A system for updating a database of patient data that is used to simulate disease progression and identify relationships affecting disease treatment and outcome by analyzing patient specific data in the context of historical data, the system comprising:
means for automatically sending requests for follow up input and providing an incentive to do so;
means for receiving and/or storing the information in a defined format; and
means for updating the database with the information.

18. A system for diagnosing and predicting disease behavior, the system comprising:
a data storage system for storage of historical disease-related data from patients;
a data retrieval system for accessing the data storage system and retrieving information relevant to an analysis of a new patient; and
a data analysis system that analyzes the historical data and determines patterns which assist in diagnosing and predicting disease behavior in the new patient when data pertaining to the new patient is entered into the data analysis system.

19. A method for predicting disease progression in a given patient, the method comprising:
entering data specific to the patient;
comparing the specific given patient data with historical data stored from many other patients with the same disease;
conducting a statistical analysis relating to the behavior of the disease in the given patient with the historical data; and
outputting a resultant analysis that predicts the likelihood of disease outcomes in the given patient based on patterns discovered in the historical patient data.

20. A method of using a database of patient data to simulate disease progression and identify relationships affecting disease treatment and outcome by analyzing patient specific data in the context of historical data, the method comprising:
prompting the user to provide specific information with regard to a patient;
receiving patent specific data;
identifying and retrieve relevant historical patient data from a database of patient data;
analyzing the patient specific information with respect to the relevant historical patient data; and
outputting information as to the patient's likely response to treatment protocols or suggested treatment options based on the analysis of the patient specific information with respect to the relevant historical patient data.
